(19) United States
(12) Patent Application Publication
(10) Pub. No.: US 2015/0146780 A1
(43) Pub. Date: May 28, 2015

(54) VIDEO ENCODER AND VIDEO ENCODING METHOD

(71) Applicant: FUJITSU LIMITED, Kawasaki-shi (JP)

(72) Inventors: Hidenobu MIYOSHI, Kawasaki (JP); Noriaki TSUKUDA, Fukuoka (JP)

(21) Appl. No.: 14/522,665

(22) Filed: Oct. 24, 2014

(30) Foreign Application Priority Data
Nov. 28, 2013 (JP) 2013-246596

(51) Int. Cl. H04N 19/593

(52) U.S. Cl. CPC H04N 19/593; H04N 19/51; H04N 19/91; H04N 19/176
USPC 375/240.12

(57) ABSTRACT

The video encoder includes: a refresh boundary determination unit which determines a position of a boundary in a second picture to be encoded based on a position of a boundary between a refreshed region and an unrefreshed region in a first picture which have been encoded and a refresh update size; and a restriction block identification unit which identifies, as a first restriction target sub-block which does not utilize a prediction vector, a first sub-block being a unit of motion compensation which is included in a refreshed region of the second picture and is possible to select a motion vector of a sub-block in the unrefreshed region of the first picture as a prediction vector of the motion vector, based on the positions of the boundaries of the first and the second pictures.

### CROSS-REFERENCE TO RELATED APPLICATION

This application is based upon and claims the benefit of priority of the prior Japanese Patent Application No. 2013-246596, filed on Nov. 28, 2013, and the entire contents of which are incorporated herein by reference.

### FIELD

The embodiments discussed herein are related to a video encoder and a video encoding method that encodes an encoding target picture by using information of another picture.

### BACKGROUND

In general, the volume of video data is huge. For this reason, an apparatus for handling video data usually performs high-efficiency encoding on video data when transmitting the video data to a different apparatus, or when storing the video data in storage. “High-efficiency encoding” is an encoding process for converting a data string into a different data string to compress data volume.

Intra-picture prediction (intra prediction) coding is known as an example of the high-efficiency coding scheme for video data. This coding scheme is based on the characteristics that video data are highly correlated in terms of space, and is performed without using any other encoded picture. Hence, a picture encoded by intra-picture prediction coding can be decoded only by using information on the picture itself.

As another example used as the high-efficiency coding scheme, inter-picture prediction (inter prediction) coding is known. This coding scheme is based on the characteristics that video data are highly correlated in terms of time. In video data, a picture at some time and a picture subsequent to the picture generally have a high degree of similarity in many cases. Hence, the inter prediction coding uses the characteristics of video data. In general, a video encoder divides an original coding-target picture into multiple coding blocks. For each block, the video encoder selects, as a reference region, a region similar to each coding block from a reference picture obtained by decoding an encoded picture, and calculates a prediction error image indicating the difference between the reference region and the coding block, to thereby exclude redundancy in terms of time. By encoding motion vector information indicating the reference region and the prediction error image, the video encoder achieves a high compression ratio. In general, inter prediction coding achieves higher compression efficiency than intra prediction coding.

Typical video coding schemes that uses above-described coding schemes and are widely used are Moving Picture Experts Group phase 2 (MPEG-2), MPEG-4, and H.264 MPEG-4 Advanced Video Coding (H.264 MPEG-4 AVC) standardized by the International Standardization Organization/International Electrotechnical Commission (ISO/IEC). In these coding schemes, the selected one of intra prediction coding and inter prediction coding for each picture is explicitly recorded in the video stream including the encoded video data, for example. The selected prediction coding scheme is referred to as a coding mode. Furthermore, when a selected encoding mode is the intra prediction coding mode, the video encoder selects only the intra prediction coding method as a prediction method for use in practice. On the other hand, when a selected encoding mode is the inter prediction coding mode, the video encoder may select the inter prediction coding method as a prediction method for use in practice and may also select the intra prediction coding method in some cases. In addition, when the inter prediction coding method is selected, the video encoder may select any vector mode among a plurality of vector modes in which encoding methods of a motion vector are different from each other.

In these video coding schemes, I picture, P picture, and B picture are defined. I picture is a picture encoded only by using information of the picture itself. P picture is a picture that is encoded according to inter-coding using information on a single encoded picture. B picture is a picture that is encoded according to bidirectional predictive coding using information on two encoded pictures. The directions indicating two reference pictures, which are referred to by a B picture, in terms of time are denoted by L0 and L1. One of the two reference pictures referred to by the B picture may be preceding the B picture in terms of time, and the other reference picture may be subsequent to the B picture in terms of time. In this case, for example, the L0 direction corresponds to the forward direction from the coding-target picture, i.e., the B picture, in terms of time, while the L1 direction corresponds to the backward direction from the coding-target picture in terms of time. Alternatively, both of the two reference pictures may be pictures preceding the B picture in terms of time. In this case, both the L0 direction and the L1 direction correspond to the forward direction from the coding target picture in terms of time. Further, both of the two reference pictures may be pictures subsequent to the B picture in terms of time. In this case, both the L0 direction and the L1 direction correspond to the backward direction from the coding-target picture in terms of time.

For real-time communication of video data that are encoded in accordance with these coding schemes, attempts have been made reducing delay in video encoders and video decoders. For example, in a scheme that aims to reduce delay according to H.264, the backward prediction, in which a picture subsequent to a coding-target picture in terms of time is referred to, is not employed in order to prevent delay due to rearrangement of pictures. A video encoder divides a picture into blocks each including 16×16 pixels. The obtained blocks are referred to as macro-blocks. A line of macro-blocks is referred to as a slice. Macro-blocks can be categorized into intra-macro-blocks for intra prediction coding, and inter-macro-blocks for inter prediction coding. To further reduce delay, an intra-refresh scheme has also been proposed, in which all the data in a slice are encoded by using as intra-macro-blocks (see Japanese Examined Patent Publication No. H06-101841, for example).

Referring to FIG. 1A and FIG. 1B, this intra-refresh scheme will be explained. FIG. 1A illustrates an example in which a refreshed region moves vertically and FIG. 1B illustrates an example in which a refreshed region moves horizontally. The horizontal axis represents time in FIGS. 1A and 1B. Each of pictures 101 to 105 is encoded as a P picture or a B picture referring to only a previous picture. The video encoder gradually shifts a position of a slice, to which the intra-refresh being applied, from the 0-th macro-block line to the t-th macro-block line, then to the (t+1)-th macro-block line for each picture. The video encoder cyclically shifts the slice, to which the intra-refresh being applied, through the entire picture in a certain refresh cycle. For example, in FIG. 1A, a refreshed region 110 being a region through which a slice to which the intra-refresh is applied has traversed is extended downward with time. In FIG. 1B, a refreshed region 120 is extended to the right with time. In the refreshed region, i.e., in the region above a refresh boundary 130 in FIG. 1A, each block is to be encoded referring only to a refreshed region of a preceding encoded picture or an encoded and refreshed region of a current picture. As a result, since the entire picture is refreshed after the slice to which the intra-refresh is applied is traversed throughout the picture, the video decoder can resume decoding from a refreshed picture even when an error occurs which causes it impossible to decode a picture due to a transmission error or the like. Furthermore, the video decoder can decode from a middle of a video stream. In addition, since an I picture containing a large amount of information is not used, the buffer in each of the video encoder and the video decoder can be small in size. As a result, latencies of the buffers can be decreased. In addition, by setting a slice to which the intra-refresh is applied to be a vertical macro-block line as illustrated in FIG. 1B, an amount of information per a macroblock line is uniformized. As a result, the video encoder can simplify an information amount control.

Note that intra prediction coding is not necessarily performed for each macro-block included in a slice to which the intra-refresh is applied, and the video encoder may perform inter prediction coding by referring only to a refreshed region of a preceding encoded picture. For example, when a region similar to an encoding target block exists in a refreshed region of a previous encoded picture, the video encoder may increase a compression ratio by selecting the inter prediction coding method.

Referring to FIG. 2, an encoding method being used in a picture according to the intra-refresh scheme will be explained. In an encoding target picture 200 and an encoded picture 210 preceding the encoding target picture, each block 201 represents a macro-block. In this example, the slice to which the intra-refresh is applied moves from left to right. In other words, refresh boundaries 202 each of which is a boundary between a refreshed region and an unrefreshed region through which a slice to which the intra-refresh is applied has not traversed are parallel to each other along a vertical direction. A macro-block to be inter-prediction-encoded in a refreshed region 221 of the encoding target picture 200 refers only to a refreshed region 231 of the encoded picture 210. While, a macro-block to be inter-prediction-encoded in an unrefreshed region 222 of the encoding target picture 200 may refer to both a refreshed region 231 and an unrefreshed region 232 of the encoded picture 210.

In a latest video encoding scheme (High Efficiency Video Coding, HEVC), a method of dividing a picture into blocks is different from a conventional encoding scheme. FIG. 3 is a diagram illustrating an example of dividing a picture by HEVC.

As illustrated in FIG. 3, a picture 300 is divided in coding blocks, i.e., coding tree units (CTUs), and the CTUs 401 are encoded in a raster scan order. The size of the CTU 301 may be selected among 64×64 to 16×16 pixels. However, the size of the CTU 301 is constant through one sequence.

The CTU 301 is further divided into a plurality of Coding Units (CUs) 302 according to a quad-tree structure. Each CU 302 in one CTU 301 is encoded in a Z scan order. The size of the CU 302 is variable and its size is selected from among CU partition modes of 8×8 to 64×64 pixels. The CU 302 is a unit to select an intra-prediction coding mode and an inter prediction coding mode which are encoding modes. The CU 302 is individually processed in units of a Prediction Unit (PU) 303 or in units of a Transform Unit (TU) 304. The PU 303 is a unit for performing prediction according to the encoding modes. For example, the PU 303 serves as a unit, in which a prediction mode is applied, in the intra prediction coding mode and serves as a unit, on which a motion compensation is performed, in the inter prediction coding mode. The size of the PU 303 may be selected from among, for example, PU partition modes Part Mode=2N×2N, N×N, 2N×N, N×2N, 2N×U, 2N×nD, nR×2N, nL×2N in the inter prediction coding. While, the TU 304 serves as a unit for orthogonal transformation and the size of the TU 304 is selected from among 4×4 pixels to 32×32 pixels. The TU 304 is divided in the quad-tree structure and is processed in the Z scan order. In this specification, a Prediction Unit is referred to as a first sub-block and a Coding Unit is referred to as a second sub-block for convenience.

### SUMMARY

In HEVC, a video encoder may obtain a motion vector in units of a PU. In HEVC, in order to encode a motion vector, an Adaptive Motion Vector Prediction (AMVP) mode for encoding a differential vector using a prediction vector and a merge mode for copying a motion vector of an encoded PU as a motion vector of an encoding target PU are defined. These modes are referred to as an inter prediction mode. In the inter prediction mode, the following are defined as vector modes to define methods for generating a prediction vector.
a spatial vector mode which uses a motion vector of a spatial neighboring block of an encoding target block,
a temporal vector mode which uses a motion vector of a neighboring block in the same region as an encoding target block in an encoded picture temporally preceding to an encoding target picture including the encoding target block,
a combined bi-directive vector mode which uses a vector of a combination of a spatial vector and a temporal vector, and
a zero vector mode which uses a zero vector.

In the AMVP mode, a prediction vector candidate list mvpListLX is generated which at most includes two candidates of vectors available as a prediction vector for each prediction direction.

FIG. 4 is an operational flowchart illustrating a procedure to determine a prediction vector in the AMVP mode. A video encoder first selects a candidate of a prediction vector from among motion vectors of blocks which have already been encoded and are adjacent to an encoding target block. In the following, a candidate of a prediction vector being selected from among motion vectors of blocks adjacent to the encoding target block is referred to as a spatial prediction vector.

In particular, the video encoder selects a motion vector of a block adjacent to the left side of the encoding target block as a spatial prediction vector mvLXA according to a predetermined sequence (Step S101).

Referring to FIG. 5, details about selecting a spatial prediction vector will be explained. FIG. 5 is a diagram illustrating a sequence of registering spatial prediction vector in the AMVP mode. With respect to an encoding target block 500, the video encoder determines whether or not to register a motion vector of each block as a spatial prediction vector in a sequence from a block A0 adjacent to the lower left thereof to a block A1 adjacent to the upper side of the block A0 as illustrated by an arrow 501.

The video encoder determines whether or not the block A0 has been encoded. When the block A0 has been encoded, the video encoder determines whether or not the block A0 is inter-prediction-encoded with respect to the same direction as the encoding target block 500. When the block A0 is inter-prediction-encoded with respect to the same direction as the encoding target block 500, the video encoder determines whether or not a reference picture refIdxLXA0 of the block A0 matches a reference picture refIdxLX of the encoding target block 500. When the reference picture refIdxLXA0 matches the reference picture refIdxLX, the video encoder selects a motion vector of the block A0 as a first spatial prediction vector mvLXA.

On the other hand, when the block A0 has not been encoded or the reference picture refIdxLXA0 does not match the reference picture refIdxLX, the video encoder performs a similar determination process on the block A1. When the block A1 has been encoded and a reference picture refIdxLXA1 referred by the block A1 matches the reference picture refIdxLX, the video encoder selects a motion vector of the block A1 as the spatial prediction vector mvLXA.

When any of the reference pictures refIdxLXA0 and refIdxLXA1 does not match the reference picture refIdxLX and the block A0 has been inter-prediction-encoded with respect to the same direction as the encoding target block 500, the video encoder selects the motion vector of the block A0. The video encoder multiplies the motion vector of the block A0 by a ratio of time between an encoding target picture including the encoding target block 500 and the reference picture refIdxLX to time between the encoding target picture and the reference picture refIdxLXA0. The video encoder sets a vector thus obtained to be the spatial prediction vector mvLXA.

When the spatial prediction vector mvLXA is not obtained by the processes described above and the block A1 is inter-prediction-encoded with respect to the same direction as the encoding target block 500, the video encoder selects the motion vector of the block A1. The video encoder then multiplies the motion vector of the block A1 by a ratio of time between the encoding target picture and the reference picture refIdxLX to time between the encoding target picture and the reference picture refIdxLXA1. The video encoder sets a vector thus obtained to be the spatial prediction vector mvLXA. Note that the spatial prediction vector mvLXA will not be selected when any of the blocks A0 and A1 is not inter-prediction-encoded with respect to the same direction as the encoding target block 500.

Then, the video encoder selects a motion vector of a block adjacent to the upper side of the encoding target block as a spatial prediction vector mvLXB according to the predetermined sequence (Step S102).

Referring to FIG. 5 again, the video encoder performs a process on blocks B0, B1 and B2 adjacent to the upper side of the encoding target block 500 in a sequence indicated by an arrow 502, the process being similar to the selection process performed on the blocks A0 and A1. The video encoder then determines whether or not to select a motion vector of those blocks as a spatial prediction vector mvLXB. Note that the block B0 is adjacent to the upper right of the encoding target block 500 and the block B1 is adjacent to the left of the block B0. The block B2 is adjacent to the upper left of the encoding target block 500.

In other words, the video encoder selects as the spatial prediction vector mvLXB a motion vector of a block wherein the reference picture thereof and the reference picture refIdxLX of the encoding target block 500 first matches in a sequence from the block B0 to B2. While, when any of the reference pictures of the blocks B0 to B2 does not match the reference picture refIdxLX, the video encoder identifies the first block which requires a motion vector in the sequence from the block B0 to B2. Then, a vector which is obtained by multiplying a motion vector of the identified block by a ratio of time between the encoding target picture and the reference picture refIdxLX to time between a reference picture referred by the identified block and the encoding target picture becomes the spatial prediction vector mvLXB.

When any of the blocks B0 to B2 is not inter-prediction-encoded with respect to the same direction as the encoding target block 500, the video encoder substitutes the spatial prediction vector mvLXA for the spatial prediction vector mvLXB. In this case, the spatial prediction vector mvLXB is also not selected when the spatial prediction vector mvLXA is not selected.

The video encoder registers the spatial vectors mvLA and mvLB in a candidate list mvpListLX (step S103). Note, however, that when the spatial prediction vector mvLXA is equal to the spatial prediction vector mvLXB, the video encoder deletes the spatial prediction vector mvLXB in the candidate list mvpListLX.

The video encoder determines whether or not a number of candidates of prediction vectors registered in the candidate list mvpListLX is more than or equal to two (step S104). When the number of candidates of the prediction vectors registered in the candidate list mvpListLX is more than or equal to two (Yes at step S104), the video encoder terminates generating the candidate list of the prediction vectors. On the other hand, when the number of the spatial prediction vectors registered in the candidate list mvpListLX is less than two (No at step S104), the video encoder performs a temporal vector mode process. Note that the video encoder may select so as not to perform a temporal vector mode process in units of slices by using a syntax sliceTemporalMvpEnabledFlag.

In the temporal vector mode process, the video encoder selects a block ColPU of a predetermined position on an encoded picture. The video encoder then determines whether or not a motion vector of the block ColPU may be used as a candidate of the prediction vector (step S105). In the following, a candidate of a prediction vector selected from among motion vectors of another encoded picture is referred to as a temporal prediction vector.

The video encoder selects a picture to become a candidate from among encoded pictures to which the encoding target block may refer. The video encoder then identifies a block ColPU adjacent to a block at the same location as the encoding target block, the block ColPU being on the selected picture ColPic.

At this point, the picture ColPic including ColPU is specified whether it is selected from the L0 direction or it is selected from the L1 direction by a syntax collocatedFromL0Flag. In addition, a picture selected as ColPic is indicated by a syntax collocatedRefldx.

Referring to FIGS. 6A to 6C, a positional relationship between an encoding target block and a ColPU will be explained. Note that one CTU 600 in a picture is illustrated in FIGS. 6A to 6C. Basically, a PU adjacent to the lower right of the PU being the encoding target block is selected as a ColPU. For example, when a CTU boundary does not exist between the encoding target block and the PU adjacent to the lower right thereof, a PU which includes a pixel at the upper left end of a 16×16 pixel grid which includes a pixel adjacent to the lower right of the encoding target block is selected as a ColPU.

For example, when a PU 610 being the encoding target block is a block larger than 16×16 pixels at the upper left in the CTU 600 as illustrated in FIG. 6A, a PU 612 adjacent to the lower right of the PU 610 becomes the ColPU in a ColPic 601 since a pixel 611 adjacent to the lower right of the PU610 is at the same position even in units of a 16×16 pixel grid.

On the other hand, when a PU 620 being the encoding target block is an upper left block among those obtained by dividing a 16×16 pixel block into four, a pixel 621 adjacent to the lower right thereof is located near the center of a 16×16 pixel grid 622. Thus, a PU 624 including a pixel 623 at the upper left end of the grid 622 becomes the ColPU.

In addition, when a CTU boundary exists between the encoding target block and a PU adjacent to the lower right thereof, a position of a pixel at the upper left of the center of the encoding target block is obtained and a 16×16 pixel grid including the pixel is identified. A PU on the ColPic including a pixel at the upper left end of the identified grid becomes the ColPU.

For example, when a PU630 being the encoding target block is located at the lower right of a CTU 600 as illustrated in FIG. 6C, a CTU boundary is located between the PU 630 and a pixel 631 at the lower right thereof. A pixel 632 at the center of the PU 630 is obtained and a 16×16 pixel grid 633 including the pixel 632 is identified. Then, a PU 635 including a pixel 634 at the upper left of the grid 633 becomes the ColPU.

Since a motion vector for a ColPU is not defined when the ColPU is a block to be intra-prediction-encoded, the video encoder is unable to utilize a motion vector of the ColPU as a prediction vector. In addition, with respect to the ColPU, when a motion vector of the L0 direction does not exist, the video encoder utilizes a motion vector of the L1 direction. On the contrary, with respect to the ColPU, when a motion vector of the L1 direction does not exist, the video encoder utilizes the motion vector of the L0 direction. Furthermore, with respect to the ColPU, when the motion vectors of both of the L0 and L1 directions exist and all of the reference pictures of the encoding target block are preceding pictures or the picture of the encoding target block, the video encoder uses a motion vector of a direction specified by the syntax collocatedFromL0Flag. On the other hand, with respect to the ColPU, when motion vectors of both of the L0 and L1 directions exist and a subsequent picture is included in the reference pictures of the encoding target block, the video encoder uses a motion vector of a direction opposite to the direction specified by the syntax collocatedFromL0Flag.

When the motion vector mvCol may be used (Yes at step S105), the video encoder registers a vector obtained by time-scaling the motion vector mvCol as a temporal prediction vector in the candidate list mvpListLX (step S106). In particular, the video encoder multiplies the motion vector mvCol by a ratio of time between an encoding target picture including the encoding target block and a picture referred by the encoding target block to time between a picture including a Col block and a picture referred by the Col block.

Following step S106 or when the motion vector mvCol may not be used at step S105 (No at step S105), it is determined whether or not a number of prediction vectors registered in the candidate list mvListLX is more than or equal to two (step S107). When the number of prediction vectors registered in the candidate list mvListLX is less than two (No at step S107), the video encoder registers a zero vector as a candidate of the prediction vector in the candidate list mvListLX (step S108). Note that the zero vector is a vector in which a value of a component representing an amount of movement in the horizontal direction and a value of a component representing an amount of movement in the vertical direction are both zero.

Following step S108 or when a number of candidates of the prediction vectors registered in the candidate list mvListLX at step S107 is more than or equal to two (Yes at step S107), the video encoder selects a candidate with a smaller error with respect to the motion vector of the encoding target block among the two candidates as a prediction vector mvpLX (step S109). The video encoder then terminates a determination procedure of the prediction vector.

The vector selected as the prediction vector mvpLX is represented by a syntax mvpLxFlag representing a position of the selected vector in the candidate list mvpListLX. Difference vectors between the syntax mvpLxFlag and the motion vector of the encoding target block and the prediction vector are entropy-encoded.

The video encoder performs the process described above on only a motion vector of the L0 direction when the encoding target picture is a P picture. While, when the encoding target picture is a B picture, the video encoder performs the process described above on motion vectors of both of the L0 and L1 directions.

In the following, a merge mode will be explained.

FIG. 7 is an operational flow chart illustrating a procedure for generating a candidate list mergCandList of a prediction vector in the merge mode. In the merge mode, the video encoder selects as a merge vector mvLXN one vector from among a number of available merge vector candidates, the number (maximum five) being indicated by a syntax MaxNumMergeCand, and represents the vector with a syntax mergeldx representing a position of a candidate list mergeCandList.

The video encoder selects a motion vector adjacent to the left or upper side of the encoding target block as a spatial prediction vector candidate according to a predetermined sequence (step S201).

Referring to FIG. 8, details about selecting a spatial prediction vector candidate will be explained. FIG. 8 is a diagram illustrating a sequence of registering a spatial prediction vector in the merge mode. The video encoder determines whether or not to register a motion vector of each block as a spatial prediction vector candidate, with respect to a PU 800 being an encoding target block, in a sequence from blocks A1, to B1, to B0, to A0 and to B2 as illustrated by arrows 801 to 804.

In addition, when a plurality of spatial prediction vector candidates have the same value, all except one among the plurality of spatial prediction vector candidates are deleted. For example, a block is assumed to be divided and, when the block lets a vector of another block be a candidate, it is deleted since dividing is not required. With respect to the block B2, when four spatial prediction vector candidates have already been selected, a motion vector of the block B2 will be excluded from the spatial prediction vector candidate. Respective spatial prediction vector candidates are set to be mvLXA0, mvLXA1, mvLXB0, mvLXB1 and mvLXB2.

The video encoder then performs a temporal vector mode process and selects a temporal prediction vector candidate mvLXCol (step S202). Note that since the temporal vector mode process in the merge mode is the same as the temporal vector mode process in the AMVP mode, detailed description of the temporal vector mode process is omitted.

The video encoder registers the selected prediction vector candidates in the candidate list mergeCandList (step S203). The video encoder then calculates a number of prediction vector candidates numOrigMergeCand registered in the candidate list mergeCandList (step S204).

The video encoder then determines whether or not the encoding target picture including the encoding target block is a B picture and numOrigMergeCand is more than or equal to two but less than MaxNumMergeCand (step S205). When a determination condition of step S205 is satisfied, the video encoder derives a combined bi-predictive vector by combining prediction vector candidates registered in the candidate list mergeCandList to add as a prediction vector candidate (step S206). The video encoder repeatedly performs a process of step S206 for numOrigMergeCand×(numOrigMergeCand−1) times or until the number of the prediction vector candidates reaches MaxNumMergeCand. A calculated vector candidate is denoted by mvLXcombCand.

FIG. 9 illustrates a table representing a relationship between the prediction vector candidate of the L0 direction and the prediction vector candidate of the L1 direction and the combine bi-predictive vector candidate mvLXcombCand when MaxNumMergeCand is four. In a table 900, l0CandIdx indicates a registration sequence of the prediction vector candidates of the L0 direction in the candidate list mergeCandList and l1CandIdx indicates a registration sequence of the prediction vector candidates of the L1 direction in the candidate list mergeCandList. combIdx indicates mvLXcombCand being derived by combining a prediction vector candidate of the L0 direction and a prediction vector candidate of the L1 direction.

Following step S206 or when a determination condition of step S205 is not satisfied, the video encoder determines whether or not the number of the prediction vector candidates is less than MaxNumMergeCand (step S207). When the number of the prediction vector candidates numOrigMergeCand is less than MaxNumMergeCand (Yes at step S207), the video encoder registers a zero vector in the candidate list mergeCandList as a prediction vector candidate until the number of prediction vector candidates reaches MaxNumMergeCand (step S208).

Following step S208 or when the number of prediction vector candidates numOrigMergeCand is more than or equal to MaxNumMergeCand (No at step S207), the video encoder selects as a merge vector mvLXN a candidate among the prediction vector candidates wherein a difference between the candidate and the motion vector of the encoding target block becomes minimum (step S209). Then, the video encoder terminates generating the candidate list mergeCandList.

Application of the AMVP mode and the merge mode is considered in a case that the intra-refresh scheme is adopted.

FIG. 10 illustrates an intra-refresh structure of HEVC. In FIG. 10, an encoding target picture 1000 is depicted in the lower side and an immediately preceding encoded picture 1010 is depicted in the upper side. In this example, a coding block CTU 1001 of each picture is a block of 64×64 pixels. The video encoder encodes the CTU 1001 one by one in a sequence from the left side (a raster scan order). Each CTU 1001 is divided in units of PUs 1002 which are units for generating a motion vector. In cases of the encoded picture 1010 and the encoding target picture 1000, positions of refresh boundaries 1003 being boundaries between refreshed regions 1005 and unrefreshed regions 1006 are different. The refresh boundary 1003 is shifted by a refresh update size 1004 in a refresh direction (in this example, a direction from left to right) between two consecutive pictures. However, the video encoder is not required to update the position of the refresh boundary for each picture and may shift the position of the refresh boundary at a certain picture interval. For simplicity, the position of the refresh boundary is assumed to be updated for each picture.

FIG. 11 is a diagram for illustrating an example in which an error propagates into a refreshed region, the error being generated by a transport error of an encoded video stream and the like and making it impossible for a picture to be correctly decoded. In FIG. 11, an encoding target picture 1100 is depicted in the lower side and an immediately preceding encoded picture 1110 is depicted in the upper side. CTUs 1111 among CTUs each included in the encoded picture 1110 are assumed to be error blocks which may not be decoded correctly due to error occurrences. The CTUs 1111 exist at the right side of a refresh boundary 1112, i.e., they are included in an unrefreshed region. In this case, since errors of the error blocks are propagated into all CTUs 1113 included in the same slice subsequent to the error blocks in a sequence of encoding, video data will not be decoded correctly unless another cycle of a refresh boundary shift is completed.

The encoding target picture 1100 will be explained in detail. A PU referring to PUs in a section 1114, in which the refreshed region is updated (i.e., expanded) for the immediately preceding encoded picture 1110, may select a motion vector of a PU in the unrefreshed region of the encoded picture 1110 as a prediction vector in the temporal vector mode. In other words, there is a possibility that a prediction vector selected in the temporal vector mode results in propagating an error to a refreshed region 1101 of the encoding target picture 1100.

According to one embodiment, a video encoder which encodes a plurality of pictures included in a video in an intra-refresh scheme is provided. This video encoder includes a refresh boundary determination unit which determines, according to a position of a boundary between a refreshed region through which a slice to which an intra-refresh is applied has traversed and an unrefreshed region through which the slice to which the intra-refresh is applied has not traversed, in a first picture, which has been encoded, among the plurality of pictures, and a refresh update size being a ratio of a size of the pictures in a moving direction of the boundary between a refreshed region and an unrefreshed region to a refresh cycle, a position of the boundary in a second picture, which is an encoding target, subsequent to the first picture among the plurality of pictures; a restriction block identification unit which identifies, based on the boundary position between the refreshed region and the unrefreshed region of the first picture and the boundary position of the second picture, among a plurality of first sub-blocks being units of motion compensation included in the second picture, as a first restriction target sub-block, a first sub-block which is included in the refreshed region and is possible to select a motion vector of the first sub-block included in the unrefreshed region of the first picture as a prediction vector of the motion vector of the first sub-block when the first sub-block is encoded in an inter prediction coding mode referring to another encoded picture; a prediction encoding unit which generates encoded data by encoding, among a plurality of second sub-blocks which are obtained by dividing the second picture and are units to be applied in the inter prediction coding mode or in an intra prediction coding mode in which only a coding target picture is referred to, a second restriction target sub-block, which is a second sub-block including the first restriction target sub-block, in the inter prediction coding mode without using the prediction vector described above with respect to the first restriction target sub-block, or by encoding the second restriction target sub-block in the intra prediction coding mode; and an entropy encoding unit which entropy-encodes the encoded data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating an example in which a refreshed region moves in the vertical direction.

FIG. 1B is a diagram illustrating an example in which a refreshed region moves in the horizontal direction.

FIG. 2 is a diagram illustrating a relationship between each region in an encoding target picture and a referable region in an encoded picture in an intra-refresh scheme.

FIG. 3 is a diagram illustrating an example of a partition of a picture according to HEVC.

FIG. 4 is an operational flowchart illustrating a procedure for determining a prediction vector in the AMVP mode.

FIG. 5 is a diagram illustrating a sequence of registering spatial prediction vectors in the AMVP mode.

Each of FIGS. 6A to 6C is a diagram illustrating an example of a positional relationship between an encoding target block and a ColPU.

FIG. 7 is an operational flowchart illustrating a procedure for generating a candidate list mergeCandList of a prediction vector in a merge mode.

FIG. 8 is a diagram illustrating a sequence of registering spatial prediction vectors in the merge mode.

FIG. 9 is a diagram illustrating a table representing a relationship between a prediction vector candidate of an L0 direction and a prediction vector candidate of an L1 direction and a combined bi-directive vector candidate mvLXcombCand.

FIG. 10 is a diagram illustrating an intra refresh structure of HEVC.

FIG. 11 is a diagram explaining an example in which an error is propagated into a refreshed region.

FIG. 12 is a diagram illustrating an example of PUs to which application of a temporal vector mode is prohibited.

FIG. 13 is a schematic structural diagram of a video encoder according to one embodiment.

FIG. 14 is an explanatory diagram of a method of determining a position of a refresh boundary.

FIG. 15 is a diagram illustrating a method of assigning an index of CTUs in the horizontal direction.

FIG. 16 is a diagram illustrating an example of inter prediction restriction target blocks.

FIG. 17 is a diagram illustrating an example of inter prediction restriction target CUs.

Each of FIGS. 18A to 18D is a diagram illustrating an index of each CU for each CU size.

FIGS. 19A to 19D are respective maps illustrating inter prediction restriction target CUs with respect to CUs with sizes of 64×64 pixels, 32×32 pixels, 16×16 pixels and 8×8 pixels when a refresh boundary is located at the right end of a CTU.

FIGS. 20A to 20D are respective maps illustrating inter prediction restriction target CUs with respect to CUs with sizes of 64×64 pixels, 32×32 pixels, 16×16 pixels and 8×8 pixels when a refresh boundary is located in a CTU.

FIGS. 21A to 21D are respective maps illustrating CUs which are not allowed to be selected, with respect to CUs with sizes of 64×64 pixels, 32×32 pixels, 16×16 pixels and 8×8 pixels when a refresh boundary is located in a CTU.

Each of FIGS. 22A to 22H is a diagram illustrating an index assigned to each PU included in one CU.

FIGS. 23A to 23H are respectively an example of maps illustrating prediction restriction target PUs when PU partition modes Part Mode are 2N×2N, N×N, 2N×N, N×2N, 2N×U, 2N×nD, nR×2N and nL×2N.

FIGS. 24A to 24H are respectively another example of maps illustrating prediction restriction target PUs when PU partition modes Part Mode are 2N×2N, N×N, 2N×N, N×2N, 2N×U, 2N×nD, nR×2N and nL×2N.

FIG. 25 is an operational flowchart of a procedure for determining a prediction vector for a prediction restriction target PU in the AMVP mode.

FIG. 26 is an operational flowchart of a procedure for determining a prediction vector for a prediction restriction target PU in a merge mode.

FIG. 27 is an explanatory diagram of a procedure for determining an encoding mode.

FIG. 28 is an operational flowchart of a video encoding process.

FIG. 29 is a diagram illustrating a method of assigning an index of CTUs in the vertical direction.

FIG. 30 is a diagram illustrating an example of inter prediction restriction target blocks according to a modified embodiment.

FIG. 31 is a configuration diagram of a computer which operates as a video encoder by executing a computer program implementing a function of each unit of the video encoder according to an embodiment or modifications thereof.

### DESCRIPTION OF EMBODIMENTS

Hereinafter, with reference to the drawings, a video encoder according to one embodiment will be described.

It is assumed that the video encoder encodes a motion vector using an AMVP scheme or a merge scheme when an intra-refresh scheme is adopted as described above. In this case, it may happen that a motion vector of a PU in an unrefreshed region, which has been selected in a temporal vector mode, results in propagating an error into a refreshed region.

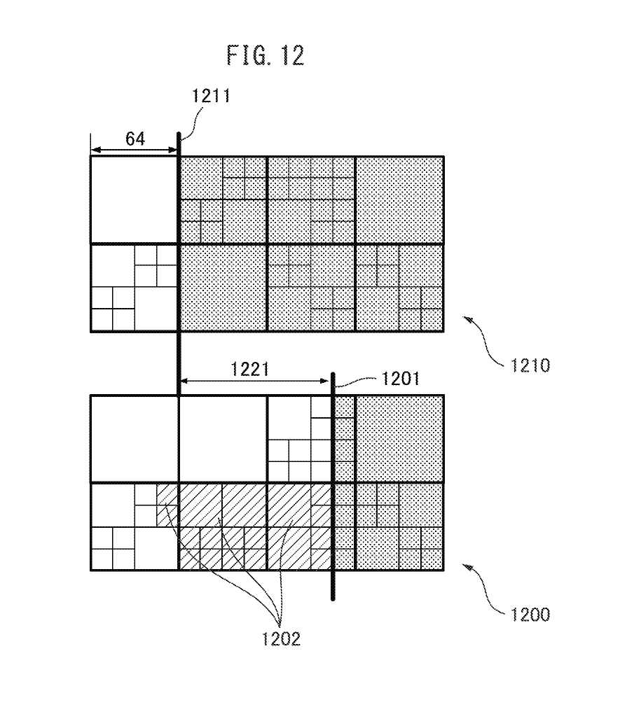

As illustrated in FIG. 12, a PU 1202 is identified which refers to, in a temporal vector mode, PUs in a section 1221 in which a refreshed region between a refresh boundary 1201 of an encoding target picture 1200 and a refresh boundary 1211 of an immediately preceding encoded picture 1210 is updated. The video encoder prohibits application of a temporal vector mode to the PU 1202. As a result, propagation of an error to the refreshed region is prevented only within a CTU line at the bottom when a refresh is performed in a subsequent picture. Therefore, the video encoder is not required to wait another shift cycle of a refresh boundary in order to correctly reproduce video data. In the embodiment, a PU is identified to which application of the temporal vector mode is prohibited depending on a positional relationship between the refresh boundary and the PU. Accordingly, a video decoder can identify a PU to which application of the temporal vector mode is prohibited even when information identifying a PU to which application of the temporal vector mode is prohibited is not notified from the video encoder.

Note that a picture may be either a frame or a field. A frame is a single still image among video data, whereas a field is a still image obtained by extracting only either data of odd rows or data of even rows from a frame.

In the embodiment, the video encoder uses HEVC as a video encoding scheme and encodes video data by means of the intra-refresh scheme. For simplicity, the refresh boundary is assumed to move in the horizontal direction. However, the refresh boundary may be the one which moves in the vertical direction. In addition, the video encoder need not move the refresh boundary for each picture but need to traverse the refresh boundary through the entire picture in a predetermined period. Note that, for the sake of convenience, a direction in which a refresh boundary is moved, i.e., a direction in which a slice to which the intra-refresh is applied is moved, is referred to as a refresh direction.

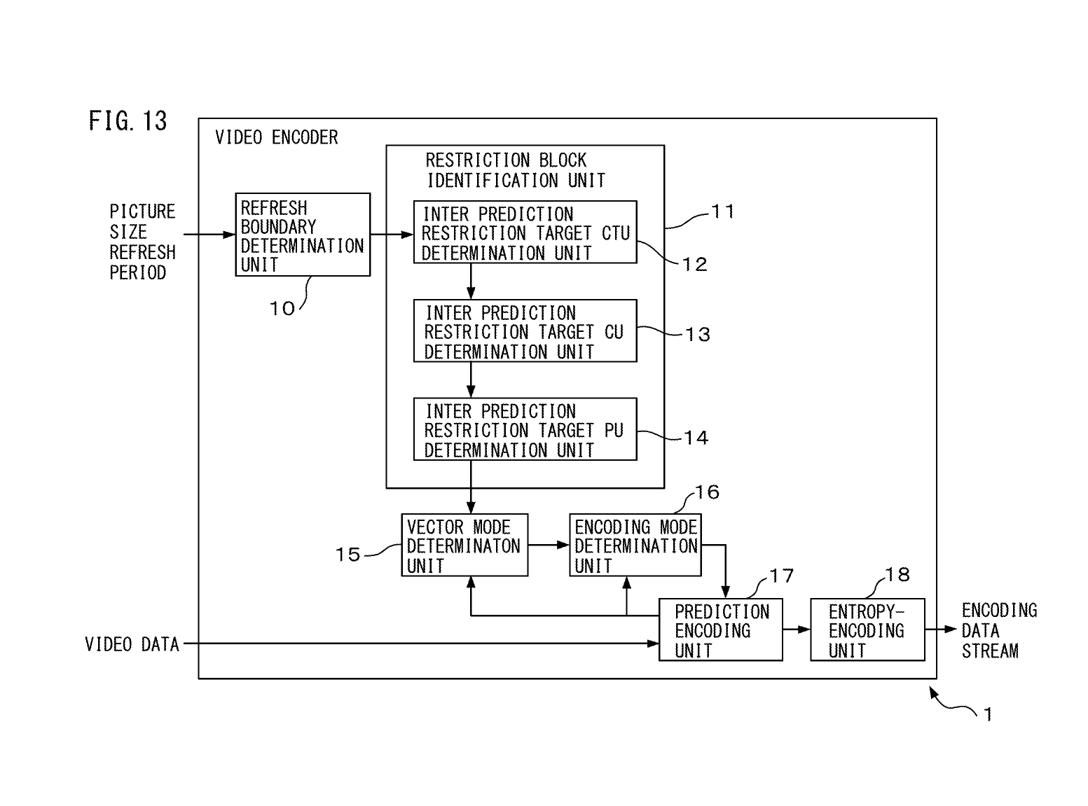

FIG. 13 is a schematic structural diagram of a video encoder according to one embodiment. A video encoder 1 includes a refresh boundary determination unit 10, a restriction block identification unit 11, a vector mode determination unit 15, an encoding mode determination unit 16, a prediction coding unit 17 and an entropy encoding unit 18. In addition, the restriction block identification unit 11 includes an inter prediction restriction target CTU determination unit 12, an inter prediction restriction target CU determination unit 13 and an inter prediction restriction target PU determination unit 14.

These units included in the video encoder 1 are formed individually as separate circuits. Alternatively, the units included in the video encoder 1 may be mounted on the video encoder 1, as a single integrated circuit with the circuits corresponding to the respective units integrated therein. Further, the units included in the video encoder 1 may be function modules that are implemented by a computer program executed on a processor included in the video encoder 1.

A coding-target picture is divided into multiple CTUs each having a predetermined number of pixels, by a control unit (not illustrated) that controls the entire video encoder 1, for example. Then, the CTUs are inputted to the video encoder 1 in the raster scan order, for example. Thereafter, the video encoder 1 encodes each CTU. In the following, the units included in the video encoder 1 will be described.

The refresh boundary determination unit 10 determines the position of a refresh boundary in a coding-target picture on the basis of a refresh cycle and the position of the refresh boundary at the time of previous update of the refresh boundary.

The refresh boundary is cyclically shifted so that a refreshed region would cover the entire picture in a predetermined refresh cycle. In this way, when a slice to which the intra-refresh is applied is shifted from one end of a picture to the other end of the picture in the refresh direction, the refreshed region covers the entire picture. Consequently, a video decoder can correctly decode the picture at this state.

A refresh cycle T is expressed by PicWidth/S, where S denotes the refresh update size, which is the size, in the refresh direction, of a slice to which the intra-refresh is applied, and PicWidth denotes the size of the picture in the refresh direction, i.e., the horizontal size of the picture in this example. For example, assume that the refresh update size with respect to a picture on a high definition television (HDTV) with 2K×1K (1920×1080) pixels is denoted by S. In this case, each of the horizontal and vertical resolutions of a picture on an ultra high definition television (UHDTV) with 4K×2K (3840×2160) pixels is twice as high as that of a picture on a HDTV. Hence, to make the refresh cycle T for an UHDTV equal to the refresh cycle for a HDTV, the refresh update size is set at 2*S. Note that the refresh cycle is not limited according to picture resolution.

In general, the refresh cycle T is set in advance and a control unit (not illustrated) calculates a refresh update size S based on the picture size and the refresh cycle T. The refresh update size S is notified to the refresh boundary determination unit 10 from the control unit. It is preferable that the refresh update size S is an integral multiple of a sub-block being a unit for selection in the intra prediction, i.e. the minimum size possible for a CU. In HEVC, the CTU size and candidates of selectable CU sizes may be set in advance. For illustration, the CTU size is assumed to be 64×64 pixels and the candidates of the CU sizes are assumed to be from 64×64 pixels to 8×8 pixels.

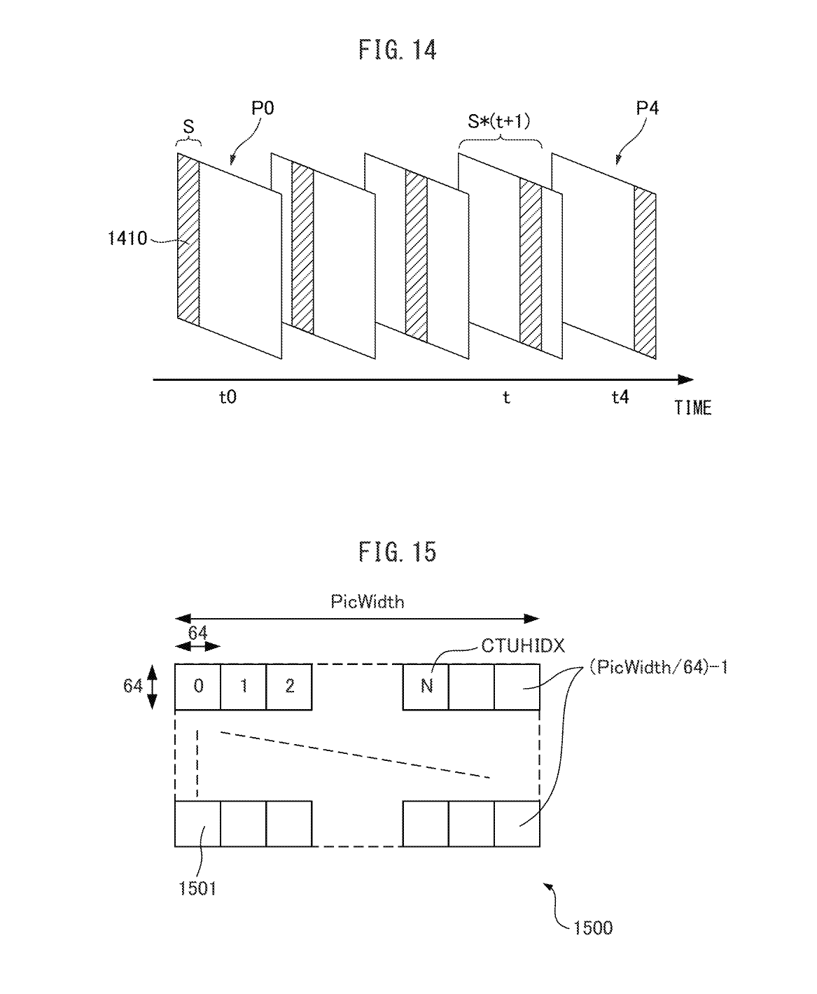

Referring to FIG. 14, a method of determining a position of the refresh boundary will be explained. In FIG. 14, the horizontal axis represents time. In a picture P0 at time to, a slice 1410 (the width of the horizontal direction thereof corresponds to the refresh update size S) to which the intra-refresh is applied is positioned at the left end of the picture and moves to the right end of the picture in a picture P4 at time t4. A number of pixels of each picture in the horizontal direction is defined as PicWidth.

The refresh boundary determination unit 10 determines the position of a refresh boundary r on the basis of the position of the refresh boundary in the picture that is immediately preceding the coding-target picture and the refresh update size S so that the refreshed region would extend rightward by the refresh update size S every picture. In this example, the refresh boundary r is represented by the horizontal coordinate of the pixels. By setting the horizontal coordinate system of each picture so that the coordinate of the leftmost pixels would be 0, the refresh boundary r in a beginning picture of the intra-refresh, i.e., the picture P0, is set to be at the position of pixels at the right end of the refreshed region (S−1). Similarly, in a picture Pt, the refresh boundary r is set at the position of the pixels at the right end of the refreshed region {S*(t+1)−1}. For the purpose of illustration, the position of the refresh boundary in the picture Pt is denoted by r(t) below.

The restriction block identification unit 11 identifies a PU which is included in the refreshed region of the encoding target picture and is possible to select a motion vector of a PU included in the unrefreshed region of the encoded picture as a temporal prediction vector of a motion vector to be used when the PU is inter-prediction-encoded. For this reason, the restriction block identification unit 11 includes the inter prediction restriction target CTU determination unit 12, the inter prediction restriction target CU determination unit 13 and the inter prediction restriction target PU determination unit 14.

The inter prediction restriction target CTU determination unit 12 determines a CTU including a PU to which application of the temporal vector mode is prohibited, based on the refresh boundary positons of the encoding target picture and an immediately preceding encoded picture. Note that a CTU including a PU to which application of the temporal vector mode is prohibited is referred to as an inter prediction restriction target block in the following.

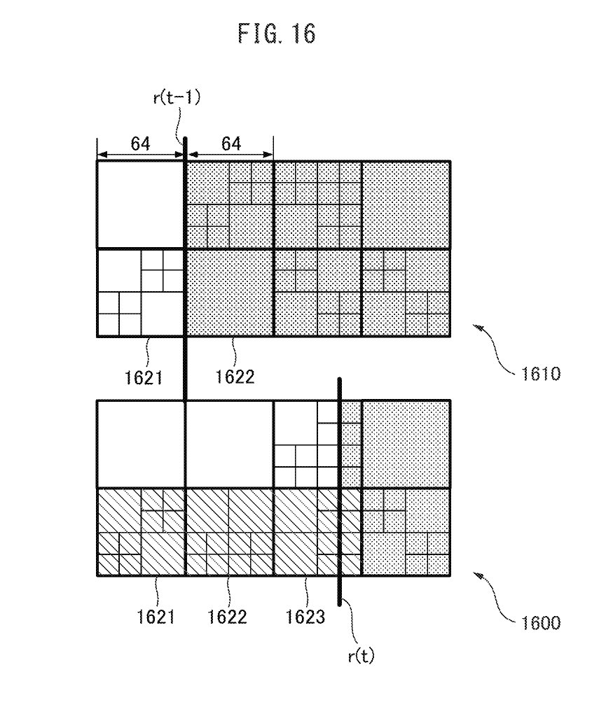

For ease of understanding a method of identifying the inter prediction restriction target block, an index for identifying a CTU, which is assigned to each CTU, is explained with reference to FIG. 15. In FIG. 15, a picture 1500 is divided into a plurality of CTUs 1501. A CTU size CTUSIZE is set to be 64 pixels. As described above, a plurality of CTUs included in a picture is encoded in a raster scan order. An index CTUIDX for identifying each CTU is set in a coding sequence. Furthermore, an index CTUHIDX of the horizontal direction of each CTU illustrated in each CTU 1501 is assigned in a sequence from the CTU at the left end since it is assumed that the refresh boundary moves from the left end to the right end of the picture. In other words, the CTUHIDX for the CTU at the left end is 0 and the CTUHIDX for the (N+1)th CTU from the left end is N. The CTUHIDX for the CTU at the right end is (PicWidth/CTUSIZE)−1. Similarly, indices CTUVIDXs for each CTU of the vertical direction are set to be 0, 1, . . . , and {(PicHeight/CTUSIZE)−1}.

An error such as a transmission error, which makes it impossible for a picture to be correctly decoded, in video data encoded in the intra-refresh scheme occurs in units of CTUs. Note that an error which makes it impossible for a picture to be correctly decoded is simply referred as an error in the following description.

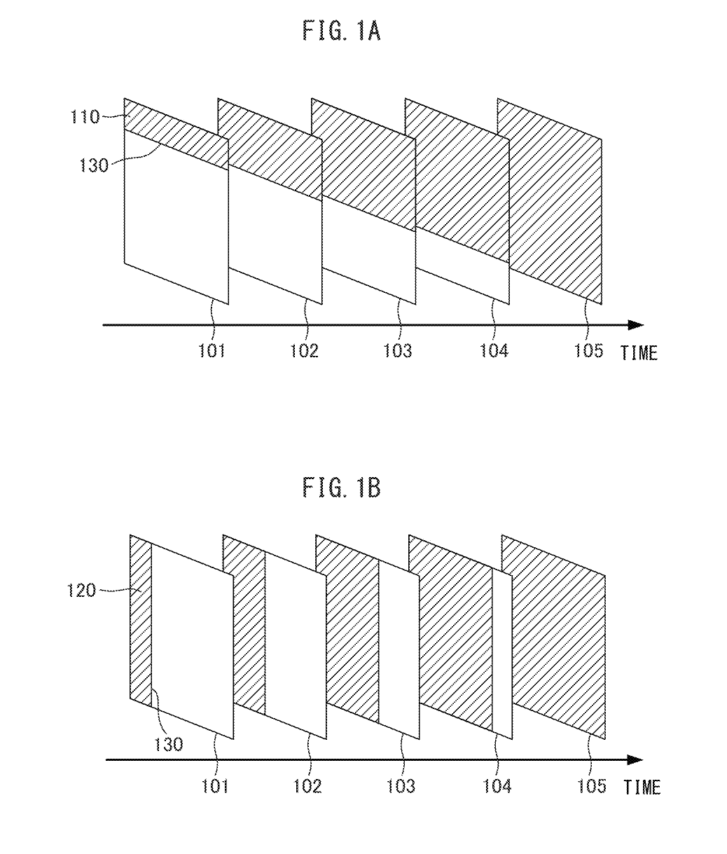

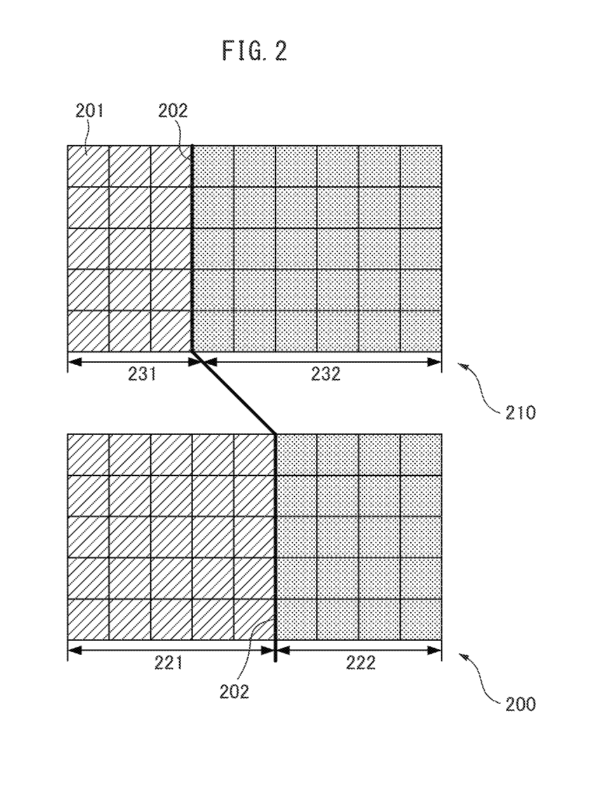

It is assumed that an error has occurred in a CTU including an unrefreshed region of an encoded picture preceding to an encoding target picture. When a refresh boundary is in a CTU and an error has occurred in an unrefreshed region side of the CTU, the error is propagated into a refreshed region since the entire CTU including the refresh boundary becomes erroneous. Therefore, the video decoder is unable to correctly decode the picture unless the refresh boundary shifts another cycle. Accordingly, it is sufficient to consider the case in which an error has occurred in a CTU subsequent to the CTU including the refresh boundary. In addition, when the refresh boundary moves in the horizontal direction as illustrated in FIG. 1B, when an error has occurred in a CTU included in a CTU line other than the bottom CTU line, an error is propagated also into a refreshed region of a CTU line adjacent to the lower side thereof. Therefore, the video decoder is also unable to correctly decode the picture unless the refresh boundary shifts another cycle. Accordingly, it is sufficient to consider a case in which an error has occurred in the bottom CTU line.

In order to prevent error propagation between pictures, the video encoder restricts reference ranges of a CU and a PU included in a refreshed region of the encoding target picture such that the CU or the PU does not refer to information of CTUs subsequent to a CTU in an unrefreshed region adjacent to a CTU including a refresh boundary in the bottom CTU line of the preceding picture.

The inter prediction restriction target CTU determination unit 12 determines each CTU as an inter prediction restriction target block, each CTU being included in the bottom line in the encoding target picture and being a CTU from a CTU which includes a position of a refresh boundary of an immediately preceding encoded picture or whose end (in this example, the right end) of the move destination side of the refresh boundary is adjacent to a position of the refresh boundary in the immediately preceding encoded picture to a CTU which includes the refresh boundary in the encoding target picture or whose end of the move destination side of the refresh boundary is adjacent to the refresh boundary in the encoding target picture. In other words, the inter prediction restriction target CTU determination unit 12 determines, as inter prediction restriction target blocks, CTUs whose index CTUVIDX of the vertical direction is {(PicHeight/CTUSIZE)−1} and whose index CTUHIDX of the horizontal direction is included between r(t−1)/CTUSIZE and r(t)/CTUSIZE.

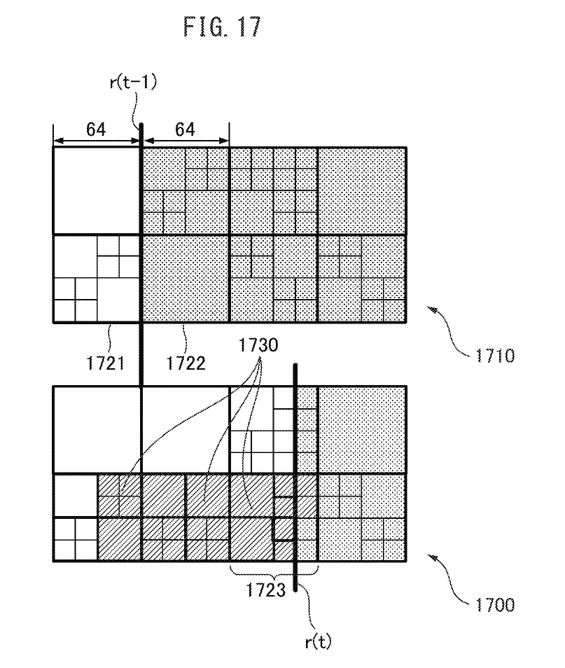

FIG. 16 is a diagram illustrating an example of inter prediction restriction target blocks. In an encoded picture 1610 immediately preceding to an encoding target picture 1600, a refresh boundary r(t−1) is assumed to be located between a CTU 1621 and a CTU 1622 of the bottom CTU line. In the encoding target picture 1600, a refresh boundary r(t) is assumed to be located in a CTU 1623 of the bottom CTU line. In this case, CTUs 1621 to 1623 become the inter prediction restriction target blocks in the encoding target picture 1600.

In the inter prediction restriction target blocks, the inter prediction restriction target CU determination unit 13 restricts application of the temporal vector mode for CUs including PUs referring to, in the temporal vector mode, PUs in an unrefreshed region of the encoded picture preceding to the encoding target picture. In the following, for convenience of explanation, a CU to which application of the temporal vector mode is restricted, i.e. a CU including a PU to which application of the temporal vector mode is prohibited, is referred to as an inter prediction restriction target CU.

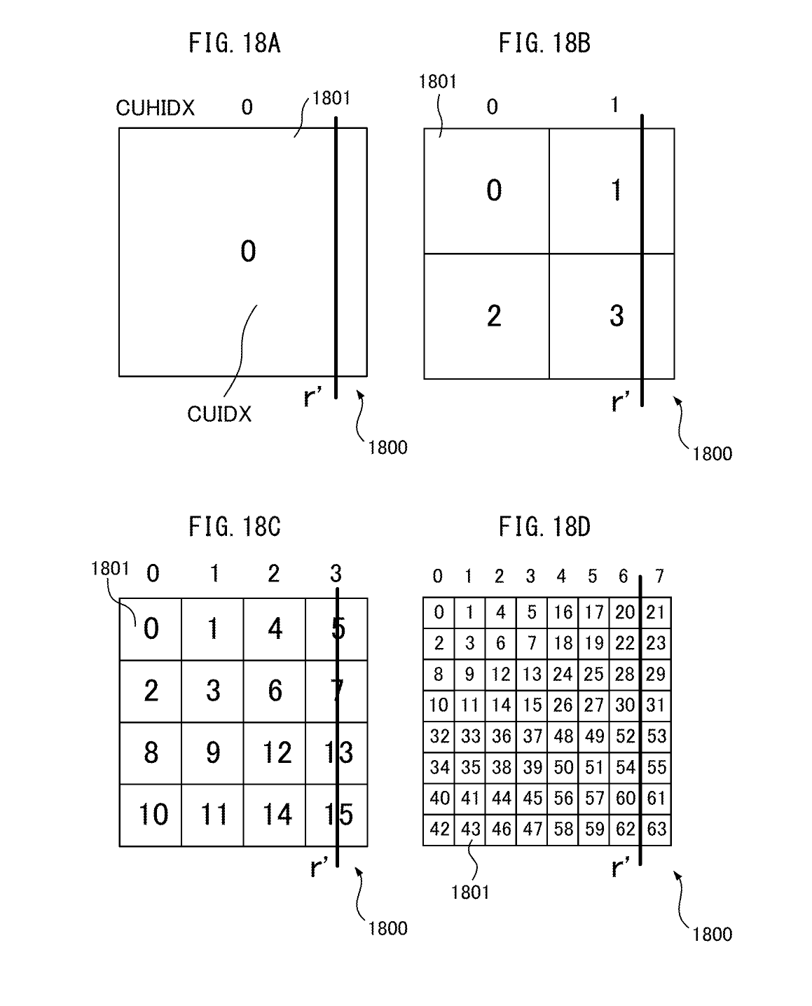

FIG. 17 is a diagram illustrating an example of inter prediction restriction target CUs. In an encoded picture 1710 immediately preceding to an encoding target picture 1700, a refresh boundary r(t−1) is assumed to be located between a CTU 1721 and a CTU 1722 of the bottom CTU line. In the encoding target picture 1700, a refresh boundary r(t) is assumed to be located in a CTU 1723 of the bottom CTU line. In this case, each CTU being hatched becomes the inter prediction restriction target block in the encoding target picture 1700.

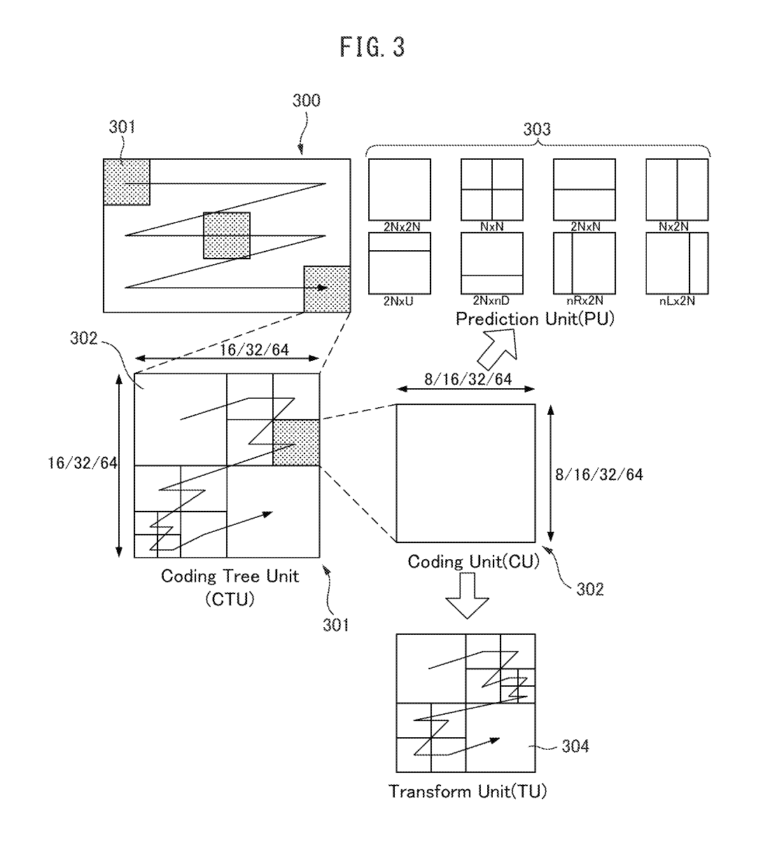

In HEVC, selectable sizes of a CU are 64×64 pixels at a maximum and 32×32 pixels, 16×16 pixels and 8×8 pixels in the quad-tree structure as illustrated in FIG. 3. This represents a hierarchical structure of the CU and an inter prediction restriction target CU is determined for each hierarchical structure of the CU in order to determine the CU size at the encoding mode determination unit 16.

Referring to FIGS. 18A to 18D, a CU index for identifying a CU which is assigned to each CU included in one CTU 1800 for each hierarchical structure will be explained. In FIG. 18A to 18D, each block 1801 represents one respective CU and a numeric number indicated in a block represents a CU index CUINDX. In addition, a numeric number indicated in the upper side of the CTU 1800 represents a horizontal CU index CUHIX. FIG. 18A represents an index CUIDX when the CU size is 64×64 pixels. Similarly, FIGS. 18B to 18D represent CU indices CUIDXs when the CU sizes are 32×32 pixels, 16×16 pixels and 8×8 pixels respectively.

The CU index CUIDX is assigned according to a coding sequence. The horizontal CU index CUHIDX being the index of a CU of the horizontal direction is assigned for each CU in a sequence from left to right in the horizontal direction since the refresh boundary is assumed to move from the left end to the right end of a picture in the embodiment.

For convenience, with respect to a CTU being an inter prediction restriction target block, a coordinate whose reference being at the left end of the CTU is defined. In this case, the refresh boundary position is specified by r′. Based on r′, determination of the inter prediction restriction target CU is explained in detail.

(1) On the Inter Prediction Restriction Target Block being CTUHIDX=r(t−1)/CTUSIZE

Let r′={(r′(t−1)/CTUSIZE)*CTUSIZE−1}, where r′ is a boundary between a CTU including a refresh boundary r(t−1) of an immediately preceding picture and a CTU being adjacent to the right side thereof. In this case, the inter prediction restriction target CU determination unit 13 sets a CTU which is adjacent to the CTU boundary and satisfies CUHIDX=r′/CUSIZE to be an inter prediction restriction CU. However, as illustrated in FIG. 6C, a position of a ColPU is modified in a CU corresponding to an encoding target PU wherein the CTU boundary is located between the encoding target PU and a PU at the lower right thereof, i.e. in a CU satisfying CUIDX={(CTUSIZE/CUSIZE)*(CTUSIZE/CUSIZE)−1}. For this reason, exceptionally, the inter prediction restriction target CU determination unit 13 need not set the CU to be the inter prediction restriction target CU.

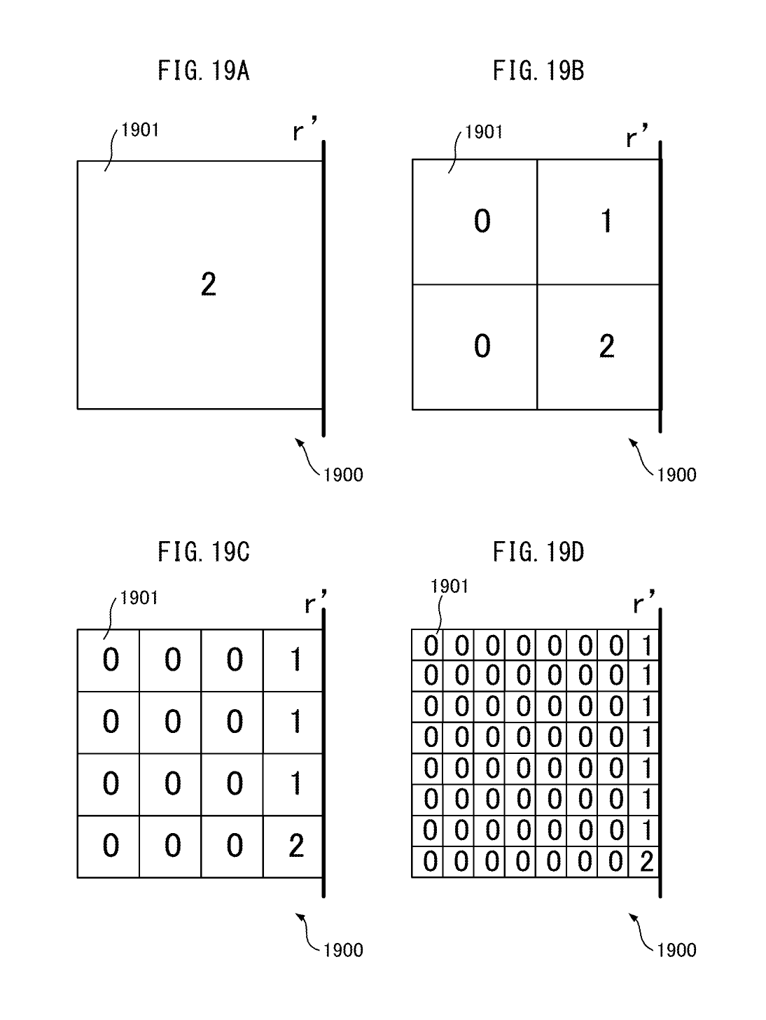

FIGS. 19A to 19D are respective maps illustrating inter prediction restriction target CUs with respect to CUs with sizes of 64×64 pixels, 32×32 pixels, 16×16 pixels and 8×8 pixels when a refresh boundary is located at the right end of a CTU 1900. Each block 1901 represents one CU respectively. Among ‘0’ to ‘2’ depicted in the CUs, ‘0’ represents that it is not an inter prediction restriction target CU. ‘1’ represents that it is an inter prediction restriction target CU. ‘2’ represents a CU to which the temporal vector mode is exceptionally not restricted among the inter prediction restriction target CUs. As illustrated in FIGS. 19A to 19D, a CU at the right end of the inter prediction restriction target block becomes an inter prediction restriction target CU. However, a CU located at the right end and the lower end of the inter prediction restriction target block is handled as an exception. Note that, for simplicity of setting, the inter prediction restriction target CU determination unit 13 may set all CUs included in the inter prediction restriction target block to be the inter prediction restriction target CUs.

(2) on the Inter Prediction Restriction Target Block being CTUHIDX=r(t)/CTUSIZE

In this case, the inter prediction restriction target CU determination unit 13 sets a CU which is included in the refreshed region of an immediately preceding picture to an encoding target picture and is adjacent to the refresh boundary r′(t) or includes the refresh boundary r(t), i.e. a CU satisfying CUHIDX=r′(t)/CUSIZE to be an inter prediction restriction target CU. However, in this case, exceptionally, the inter prediction restriction target CU determination unit 13 also need not set a CU corresponding to an encoding target PU wherein the CTU boundary is located between the encoding target PU and a PU at the lower right thereof, i.e., a CU satisfying CUIDX={(CTUSIZE/CUSIZE)*(CTUSIZE/CUSIZE)−1} to be an inter prediction restriction target CU.

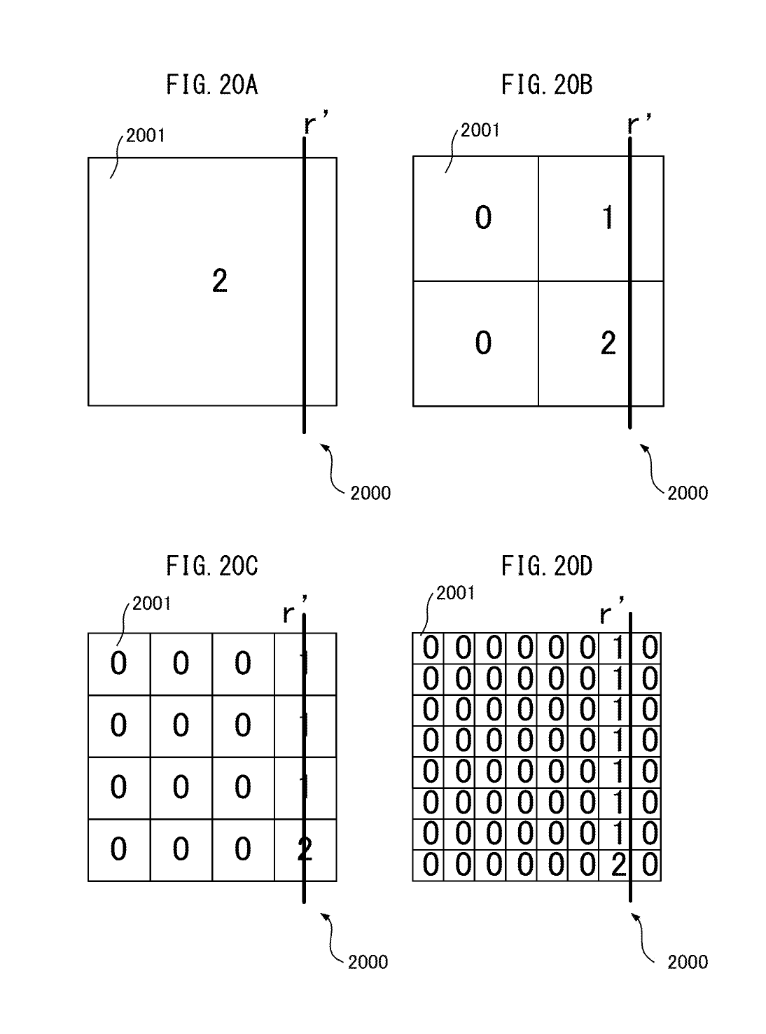

FIGS. 20A to 20D are respective maps illustrating inter prediction restriction target CUs for CUs with sizes of 64×64 pixels, 32×32 pixels, 16×16 pixels and 8×8 pixels when the refresh boundary r′ is located in a CTU 2000. Each block 2001 represents one CU respectively. Among ‘0’ to ‘2’ depicted in the CUs, ‘0’ represents that it is not an inter prediction restriction target CU. ‘1’ represents that it is an inter prediction restriction target CU. ‘2’ represents a CU, to which the temporal vector mode is exceptionally not restricted, among the inter prediction restriction target CUs. As illustrated in FIGS. 20A to 20C, when the refresh boundary r′ is included in a CU, the CU becomes the inter prediction restriction target CU. Furthermore, as illustrated in FIG. 20D, when the refresh boundary r′ is located between two adjacent CUs, a CU adjacent to the left side of the refresh boundary r′, i.e., a CU whose right end is the refresh boundary r′, becomes the inter prediction restriction target CU. However, a CU located at the lower right end of the inter prediction restriction target block is handled as an exception. Note that, for simplicity of setting, the inter prediction restriction target CU determination unit 13 may set all CUs included in the inter prediction restriction target block to be the inter prediction restriction target CUs.

(3) on the Inter Prediction Restriction Target Blocks Other than (1) and (2)

The inter prediction restriction target CU determination unit 13 sets all CUs included in the inter prediction restriction target block to be the inter prediction restriction target CUs. In other words, when a CU restriction index is arranged such that a CU which is not an inter prediction restriction target CU is set to be ‘0’ and an inter prediction restriction target CU is set to be ‘1’, the index of all CUs included in the inter prediction restriction target block is ‘1’.

Note that the inter prediction restriction target CU determination unit 13 may restrict selectable CU sizes. For example, the inter prediction restriction target CU determination unit 13 may restrict a partition of a CU to be selected in a CTU by defining a value indicating invalidity as a CU restriction index. As described above, a CU is a unit in which a coding mode is determined and the video encoder 1 may select one of an intra prediction coding mode and an inter prediction coding mode as an encoding mode for each CU. As will be described in detail later, there is a possibility that a CU is intra-prediction-encoded, which includes a PU referring, in the temporal vector mode, to a PU in an unrefreshed region of an encoded picture preceding to an encoding target picture. Since a compression efficiency of the intra prediction coding mode is generally lower than that of the inter prediction coding mode, it is preferable that the size of a CU to which the intra prediction coding mode is applied is set to be the minimum size among selectable CU sizes. For example, a value of a CU restriction index indicating that the CU size is invalid is set to be ‘3’. In this case, in the examples depicted in FIGS. 20A to 20D, it is arranged such that, with respect to CUs with the minimum size CUSIZE=8, a CU to which application of the temporal vector mode is restricted (i.e., a CU whose CU restriction index is non-zero) is selected. For this reason, when the CU size is larger than 8, the inter prediction restriction target CU determination unit 13 sets to be ‘3’ a value of the CU restriction index of a CU whose CU restriction index is non-zero and which includes the same position as a CU with the minimum size.

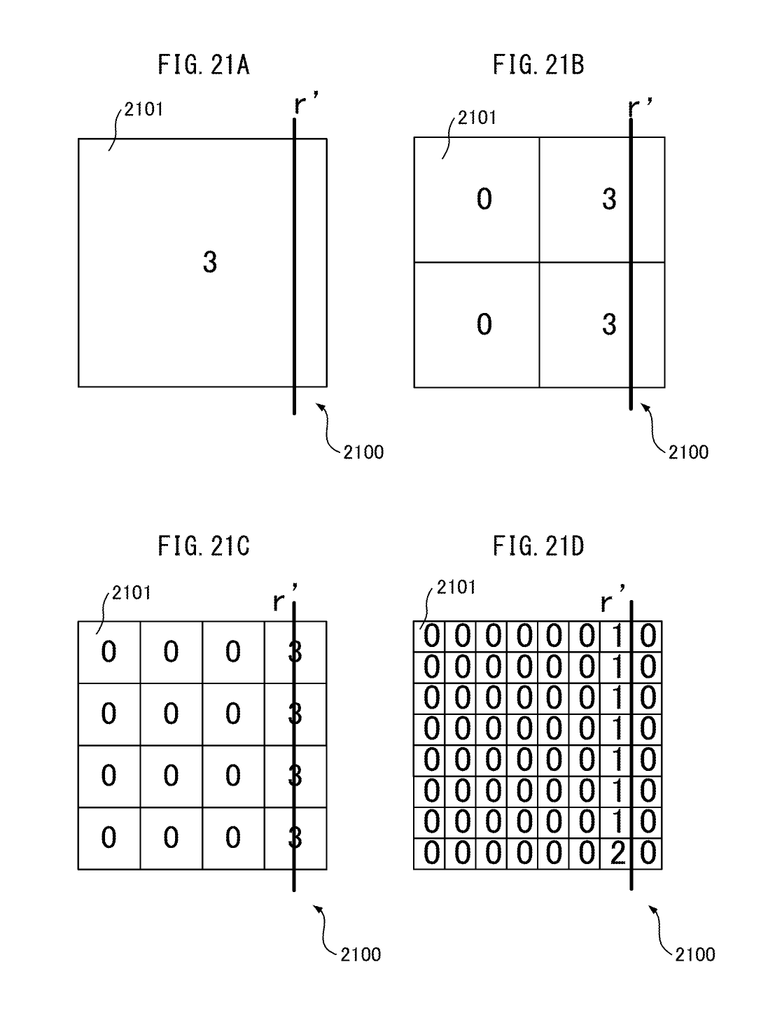

FIGS. 21A to 21D are respective maps illustrating CUs which are not allowed to be selected, with respect to CUs with sizes of 64×64 pixels, 32×32 pixels, 16×16 pixels and 8×8 pixels when a refresh boundary r′ is located in a CTU 2100. Each block 2101 represents one CU. A numerical number depicted in a CU represents a value of the CU restriction index. As illustrated in FIGS. 21A to 21C, a CU to which application of the temporal vector mode is restricted, which includes an inter prediction restriction target CU (refer to FIG. 21D) with the minimum size and whose size is larger than the minimum size is set to be unselectable i.e., invalid. Note that the inter prediction restriction target CU determination unit 13 may set all CUs other than those with the minimum size to be invalid when further simplification is performed.

The inter prediction restriction target PU determination unit 14 prohibits application of the temporal vector mode to a PU referring, in the temporal mode, to a PU in an unrefreshed region of an encoded picture preceding to an encoding target picture in an inter prediction restriction target CU. In the following, for convenience of explanation, a PU to which application of the temporal vector mode is prohibited is referred to as an inter prediction restriction target PU.

In HEVC, selectable sizes of a CU are 64×64 pixels at a maximum and 32×32 pixels, 16×16 pixels and 8×8 pixels in the quad-tree structure as illustrated in FIG. 3. CUs of respective sizes are divided into a plurality of PUs according to the PU partition mode Part Mode=2N×2N, N×N, 2N×N, N×2N, 2N×U, 2N×nD, nR×2N, nL×2N illustrated in FIG. 3. In other words, PUs are also in the hierarchical structure with respect to CUs. Thus, inter prediction restriction target PUs are determined for each hierarchical structure of the CUs.

Referring to FIGS. 22A to 22H, a PU index PUIDX for identifying a PU, which is assigned to each PU included in one CU 2200, will be explained. FIGS. 22A to 22H represent indices PUIDXs when the PU partition modes Part Mode are 2N×2N, N×N, 2N×N, N×2N, 2N×U, 2N×nD, nR×2N and nL×2N respectively. In FIGS. 22A to 22H, each block 2201 represents one PU and a numerical number depicted in a block represents a PU index PUIDX. Furthermore, a numerical number depicted at the upper side of a CU 2200 represents a PU index PUHIDX of the horizontal direction.

The index PUIDX is assigned in a PU coding sequence. The PU index PUHIDX of the horizontal direction is assigned in a sequence from left to right in the horizontal direction for each PU since the refresh boundary is assumed to move from the left end to the right end of the picture.

The inter prediction restriction target PU determination unit 14 sets to be a CU of interest a CU whose CU restriction index is ‘1’ or ‘2’, referring to a CU restriction map indicating the inter prediction restriction target CU, which is a map of a restriction index for each CU. Then the inter prediction restriction target PU determination unit 14 determines whether or not to refer, in the temporal vector mode, to a PU in an unrefreshed region of an encoded picture preceding to an encoding target picture for each PU included in the CU of interest.

In particular, the inter prediction restriction target PU determination unit 14 sets, to be an inter prediction restriction target PU, a PU which is included in a CTU satisfying CTUHIDX=r(t−1)/CTUSIZE or CTUHIDX=r(t)/CTUSIZE and which satisfies PUHIDX=r′/PUHSIZE among PUs included in a CU with the restriction index being ‘1’. PUHSIZE represents a PU size of the horizontal direction.

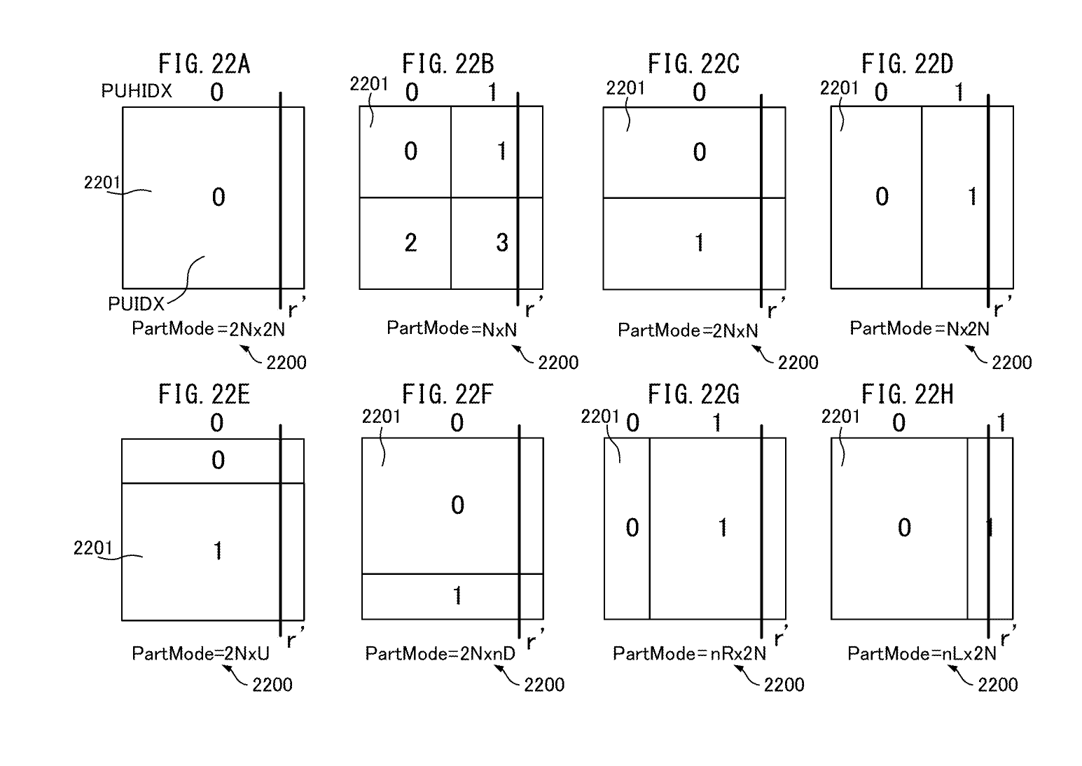

For example, the refresh boundary r′ is assumed to be set in a CTU as illustrated in FIGS. 22A to 22H (i.e., CTUHIDX=r(t)/CTUSIZE). Furthermore, CUSIZE is assumed to be 64, i.e., a number of CUs included in the CTU is assumed to be one. In this case, when PU partition modes Part Mode are 2N×2N, N×N, 2N×N, N×2N, 2N×U, 2N×nD, nR×2N and nL×2N, maps illustrating prediction restriction target PUs are illustrated in FIGS. 23A to 23H. Each block 2301 represents one PU respectively in FIGS. 23A to 23H. A numerical number depicted in a PU is a value of a PU restriction flag set for the PU. The value ‘0’ of the PU restriction flag represents that the corresponding PU is not an inter prediction restriction target PU. Whereas, the value ‘1’ of the PU restriction flag represents that the corresponding PU is an inter prediction restriction target PU. As illustrated in FIGS. 23A to 23H, a PU which overlaps with the refresh boundary r′ or is adjacent to the left side of the refresh boundary r′ is set to be an inter prediction restriction target PU.

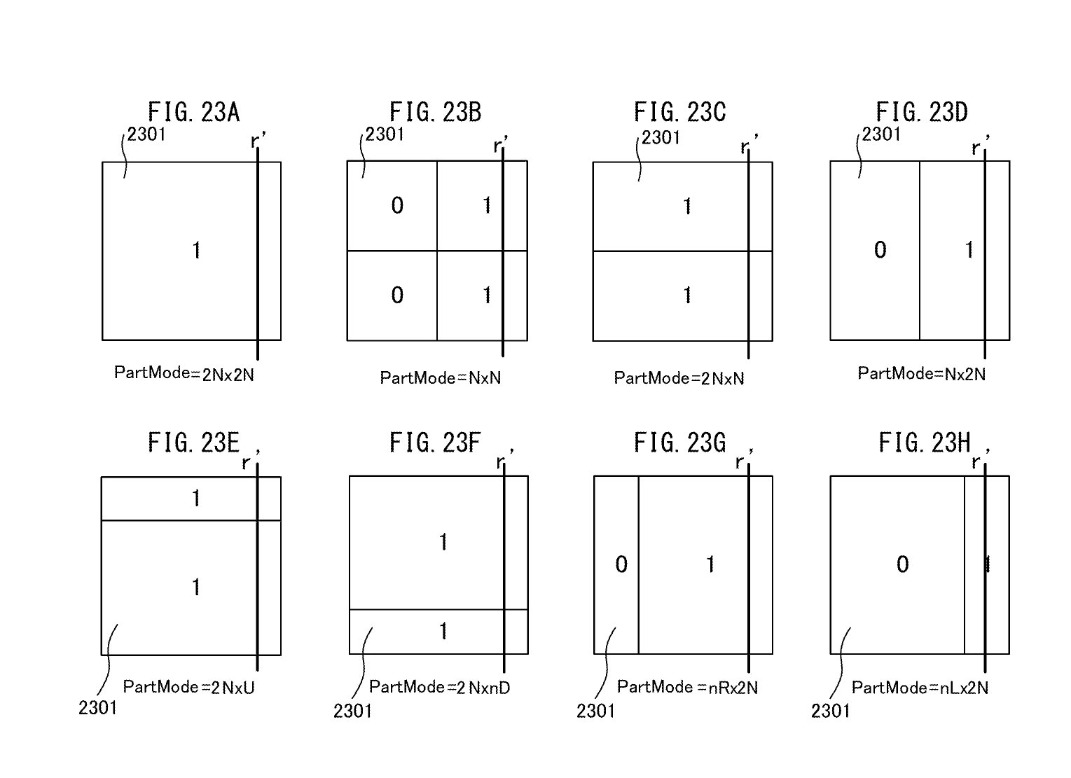

The inter prediction restriction target PU determination unit 14 may exclude, as an exception, a PU from the inter prediction restriction target PU wherein a CTU boundary is located between the PU and a PU at the lower right thereof (i.e., a PU restriction flag thereof is set to be ‘0’) among PUs included in CUs whose CU restriction index is ‘2’. For the PU, wherein a CTU boundary is located between the PU and a PU at the lower right thereof, a ColPU is set to overlap with the PU such that a prediction vector candidate selected in the temporal vector mode does not refer to an unrefreshed region. In this case, maps illustrating prediction restriction target PUs when PU partition modes Part Mode are 2N×2N, N×N, 2N×N, N×2N, 2N×U, 2N×nD, nR×2N and nL×2N are those illustrated in FIGS. 24A to 24H. In FIGS. 24A to 24H, each block 2401 represents one PU respectively. A numerical number depicted in a PU is a value of a PU restriction flag set for the PU.

In addition, the inter prediction restriction target PU determination unit 14 sets, to be the prediction restriction target PU, PUs included in all CTUs included between a CTU satisfying CTUHIDX=r(t−1)/CTUSIZE and a CTU satisfying CTUHIDX=r(t)/CTUSIZE. In other words, in a PU restriction map for all CUs included between a CTU satisfying CTUHIDX=r(t−1)/CTUSIZE and a CTU satisfying CTUHIDX=r(t)/CTUSIZE, values of PU restriction flags for all PUs are ‘1’. Note that since a CU whose value of the CU restriction index is ‘3’ (invalid) is not set, a PU included in such a CU is invalid. For this reason, for a PU included in a CU whose value of the CU restriction index is ‘3’, the inter prediction restriction target PU determination unit 14 does not determine whether or not it is a prediction restriction target PU and need not set the PU restriction target flag.

The vector mode determination unit 15 determines a prediction vector of a motion vector of an encoding target PU. For a prediction restriction target PU, the vector mode determination unit 15 prohibits application of the temporal vector mode in a vector mode determination of selectable inter prediction modes for the prediction restriction target PU and sets a prediction vector candidate to be a motion vector to be selected in the spatial vector mode. The vector mode determination unit 15 then determines a prediction vector among prediction vector candidates selected in the spatial vector mode.

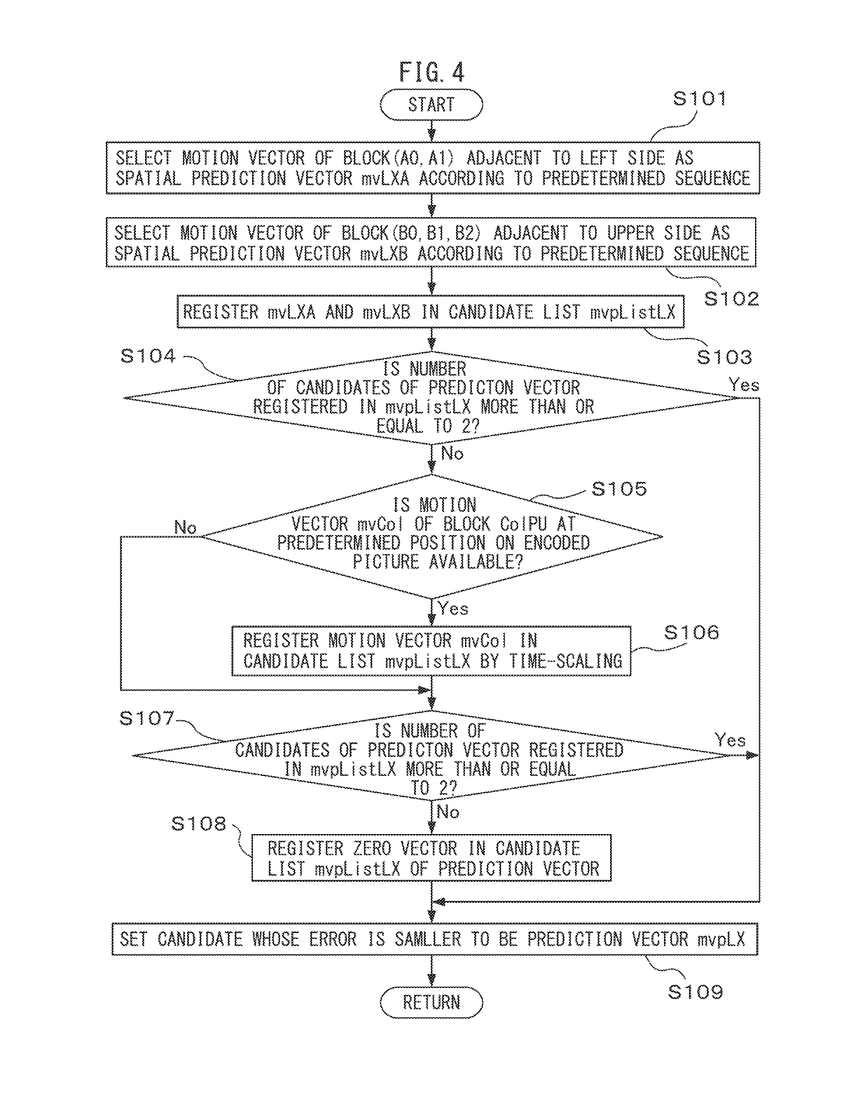

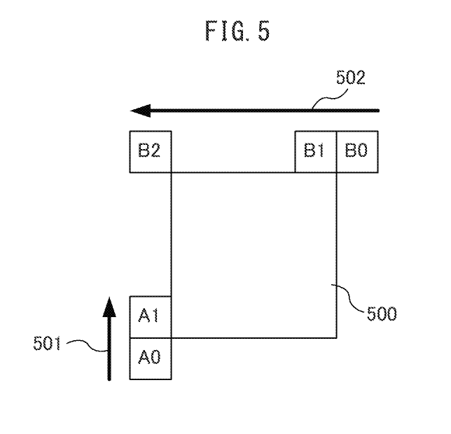

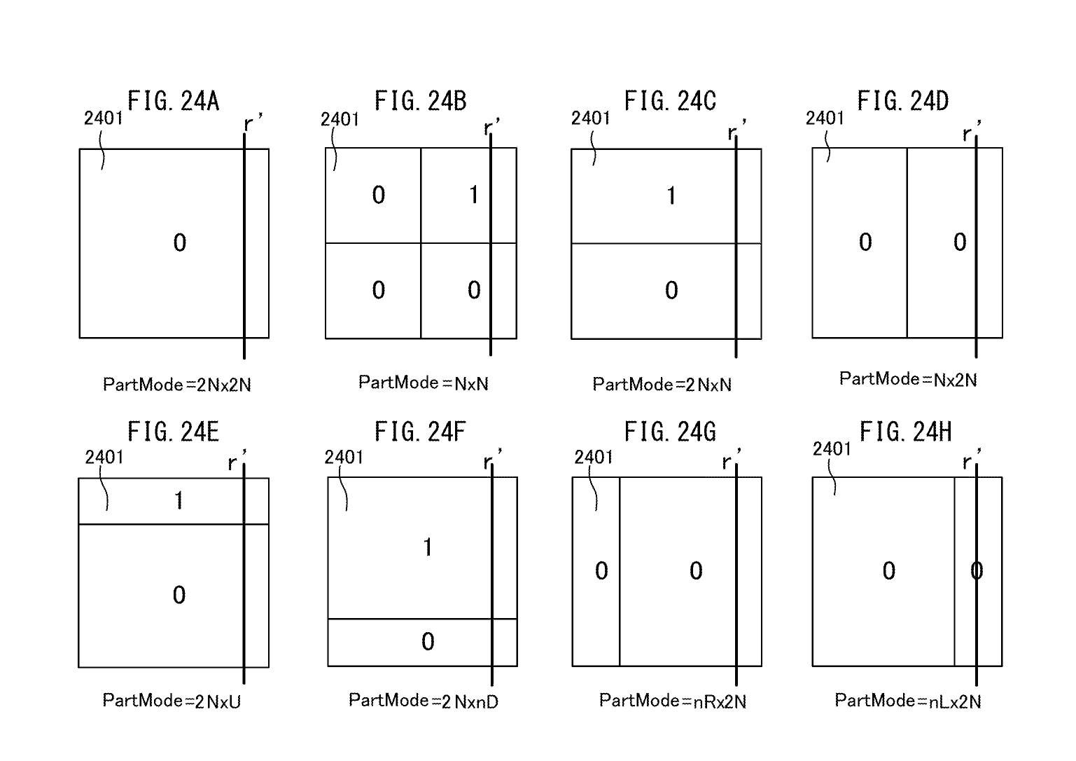

FIG. 25 is an operational flowchart of a procedure for determining a prediction vector for a prediction restriction target PU in the AMVP mode by the vector mode determination unit 15. After performing processes of steps S101 to S103 in the flowchart illustrated in FIG. 4, the vector mode determination unit 15 performs processes of step S301 and the subsequent steps illustrated in FIG. 25. Note that the vector mode determination unit 15 may determine a prediction vector for a PU other than a prediction restriction target PU according to the flowchart illustrated in FIG. 4.

The vector mode determination unit 15 determines whether or not mvLXA or mvLXB is registered in the prediction vector candidate list mvpListLX (step S301). When mvLXA or mvLXB is registered in the prediction vector candidate list mvpListLX (Yes at step S301), the vector mode determination unit 15 sets the one registered in the prediction vector candidate list mvpListLX among mvLXA and mvLXB to be a prediction vector mvpLX (step S302). Note that, when both mvLXA and mvLXB are registered, the vector mode determination unit 15 may set, to be the prediction vector mvpLX, the one whose error against the motion vector of the encoding target PU among mvLXA and mvLXB is smaller, i.e., the one whose information amount is smaller. The vector selected as the prediction vector mvpLX is represented by a syntax mvpLxFlag representing a position of the selected vector in the candidate list mvpListLX. The syntax mvpLxFlag and a difference vector between the motion vector of the encoding target PU and the prediction vector are entropy-encoded.

Whereas, when both mvLXA and mvLXB are not registered (No at step S301), the vector mode determination unit 15 sets the prediction vector mvpLX to be invalid (step S303). After step S302 or S303, the vector mode determination unit 15 terminates determining the prediction vector.

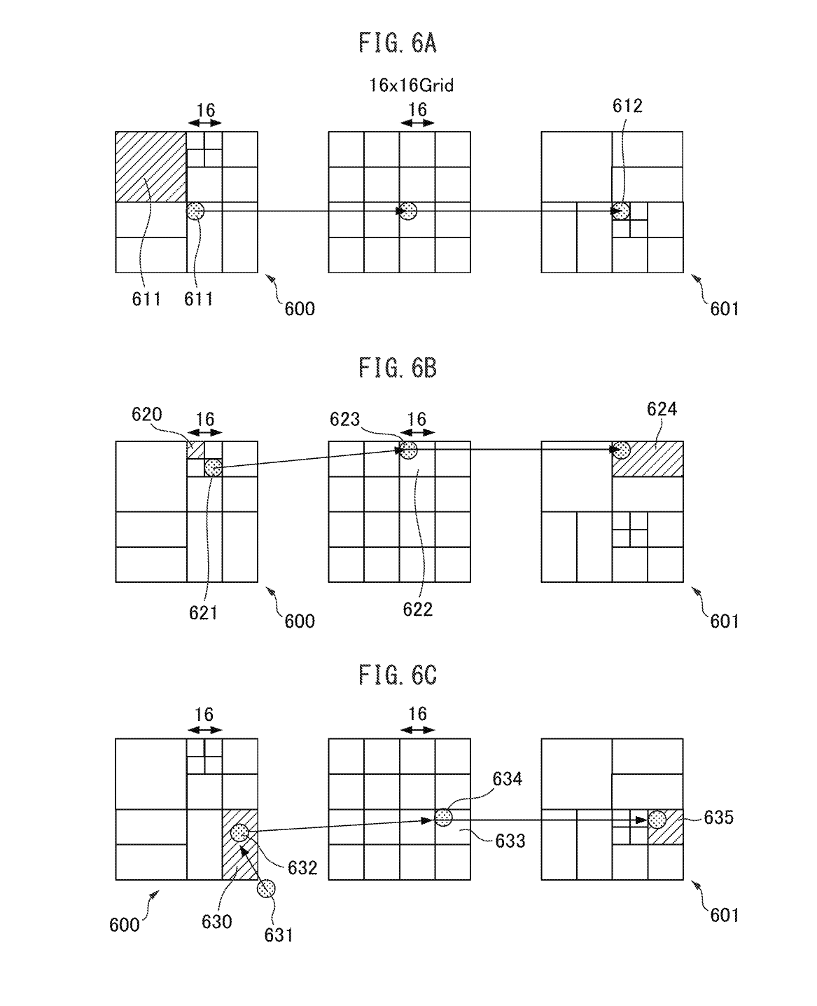

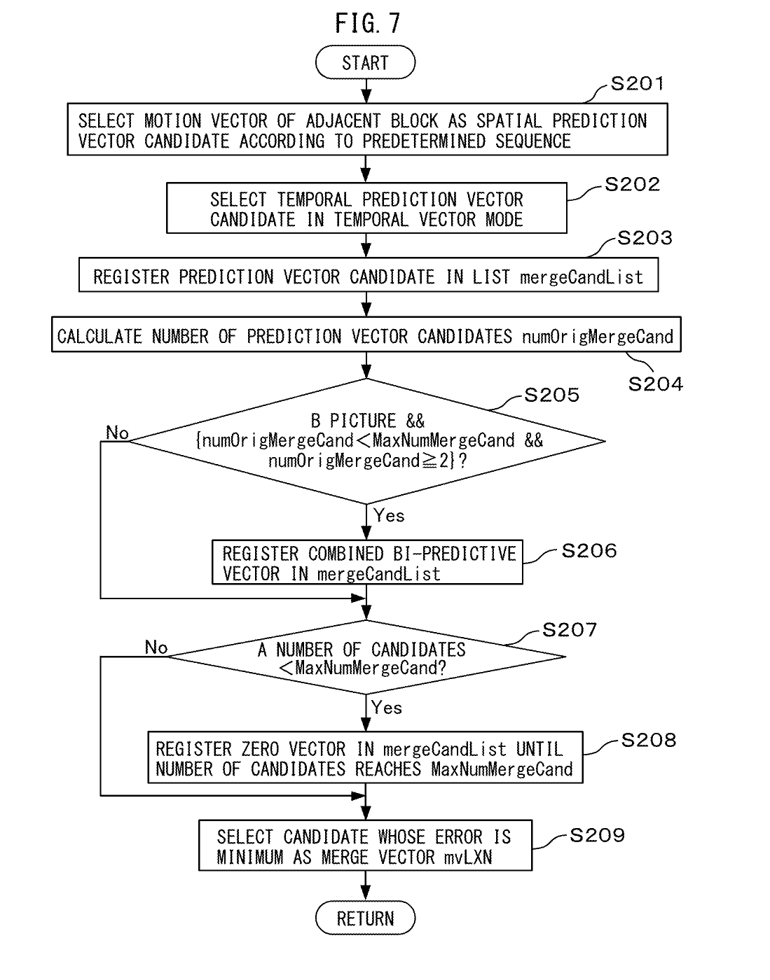

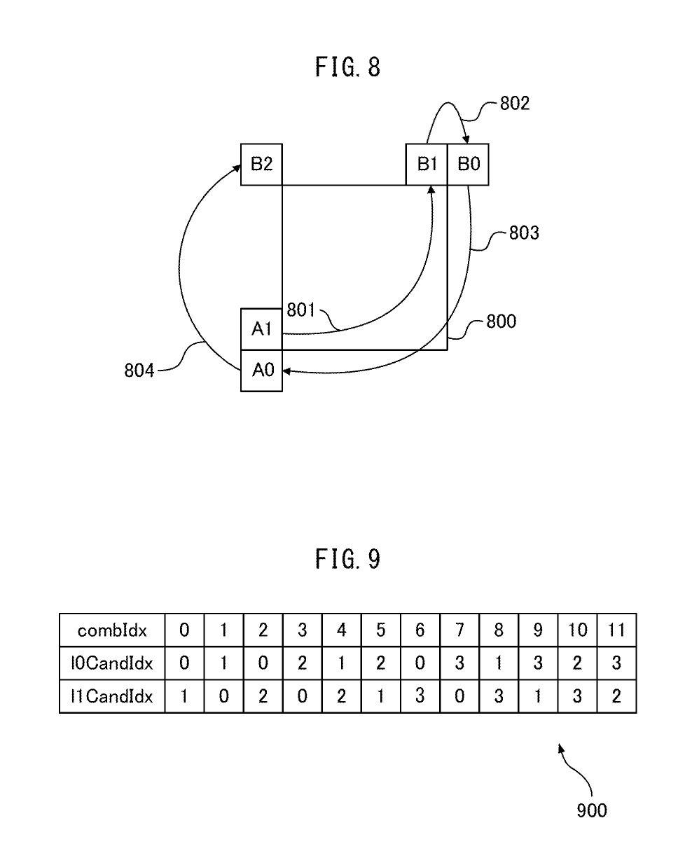

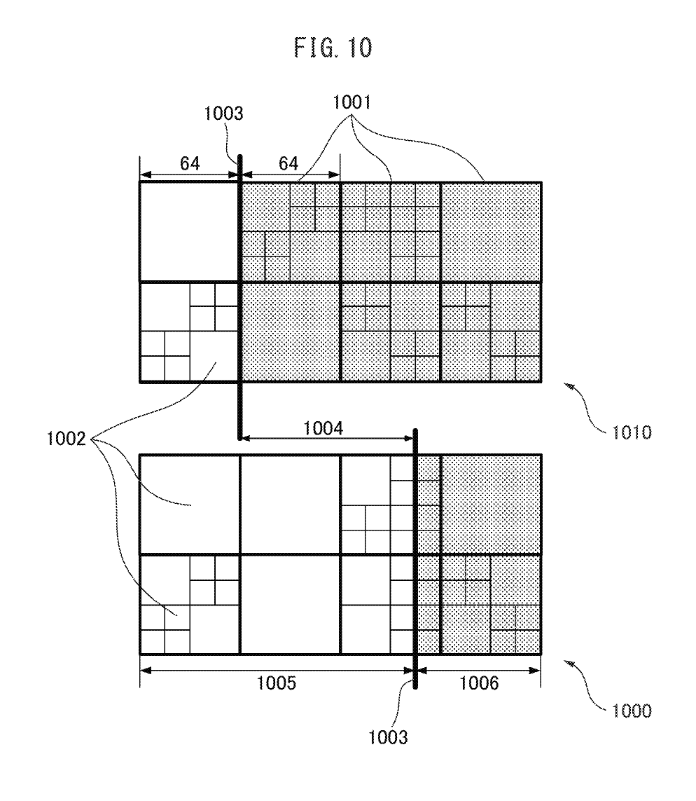

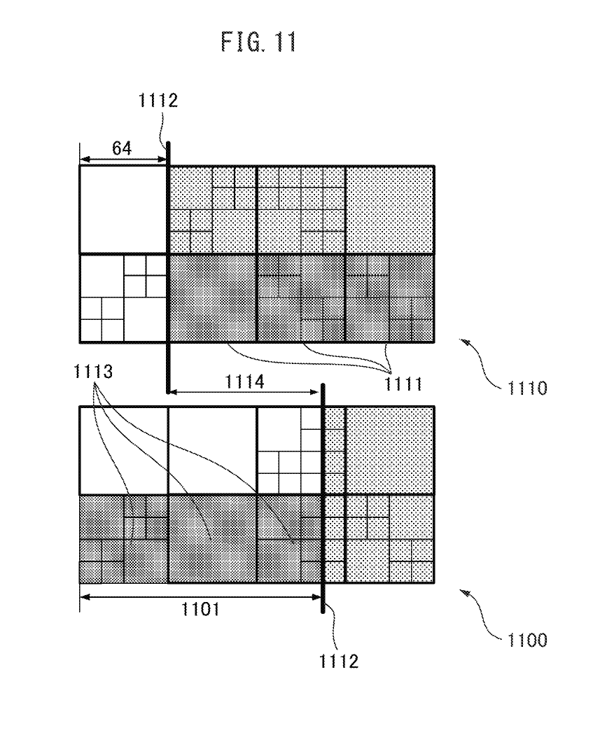

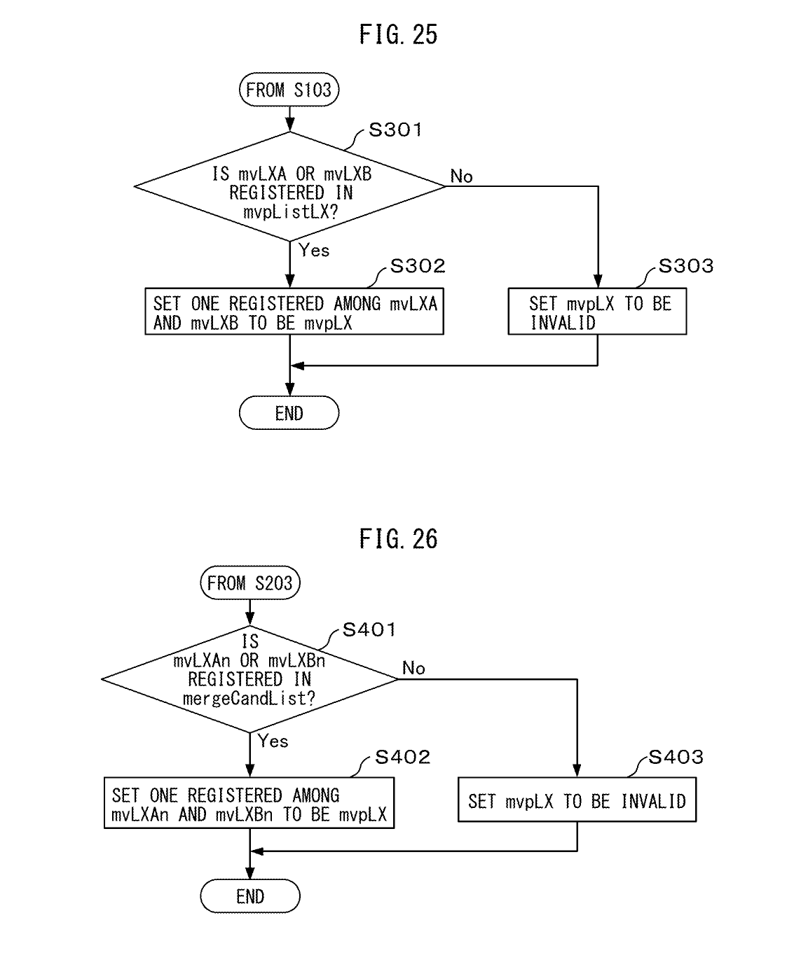

FIG. 26 is an operational flowchart of a procedure for determining a prediction vector for a prediction restriction target PU in a merge mode by the vector mode determination unit 15. After having performed processes of steps S201 and S203 in the flowchart illustrated in FIG. 7, the vector mode determination unit 15 performs processes of step S401 and the subsequent steps illustrated in FIG. 26. However, the vector mode determination unit 15 may determine a prediction vector for a PU other than the prediction restriction target PU according to the flowchart illustrated in FIG. 7.

After having generated a merge vector candidate list mergeCandList (includes five candidates at a maximum), the vector mode determination unit 15 determines whether or not a prediction vector candidate mvLXAn or mvLXBn selected in the spatial vector mode is registered in the mergeCandList (step S401). When any of mvLXAn and mvLXBn is registered in the merge vector candidate list mergeCandList (Yes at step S401), the vector mode determination unit 15 sets any of those registered among mvLXAn and mvLXBn to be the prediction vector mvpLX (step S402). Note that, when more than one among mvLXAn and mvLXBn are registered, the vector mode determination unit 15 may set, to be the prediction vector mvpLX, the one whose error against the motion vector of the encoding target PU is minimum among registered mvLXAn and mvLXBn, i.e., the one whose information amount is minimum. The vector selected as the prediction vector mvpLX is represented by a syntax mergeldx representing a position of the selected vector in the candidate list mergeCandList. The syntax mergeldx is entropy-encoded.

Whereas, any of mvLXAn and mvLXBn is not registered (No at step S401), the vector mode determination unit 15 sets the prediction vector mvpLX to be invalid (step S403). Following step S402 or S403, the vector mode determination unit 15 terminates determining the prediction vector. Note that, in synchronization with a process performed on a PU by the encoding mode determination unit 16, the vector mode determination unit 15 may perform a procedure for determining the prediction vector for the PU.

The encoding mode determination unit 16 determines the encoding mode for each CU of the encoding target picture. Furthermore, the encoding mode determination unit 16 determines the inter prediction mode for each PU.

For a PU whose prediction vector mvpLX is set to be invalid in FIG. 25 or 26, the encoding mode determination unit 16 determines to intra-prediction-encode the CU including the PU.

The encoding mode determination unit 16 selects one combination among combinations of CU partition modes (CU size) and PU partition modes in an encoding target CTU of the encoding target picture to determine the inter prediction mode corresponding to the selected combination. In addition, the encoding mode determination unit 16 determines the encoding mode, i.e., whether to intra-prediction-encode or to inter-prediction-encode, for the combination.

The encoding mode determination unit 16 calculates an encoding cost being an estimation value of a code amount for each of combinations of the CU partition modes and the PU partition modes in order to determine the CU partition mode and the PU partition mode and selects a combination whose encoding cost is minimum. The encoding mode determination unit 16 calculates a prediction error, i.e., a pixel difference absolute value sum SAD, according to the following equation in order to calculate the encoding cost.

SAD=Σ|OrgPixel−PredPixel|

Where, OrgPixel is a value of a pixel included in a block, for example a PU, of interest of the encoding target picture and PredPixel is a value of a pixel included in a prediction block corresponding to the block of interest, required in the HEVC standard. However, instead of SAD, the encoding mode determination unit 16 may calculate the absolute value sum SAID of each pixel after a difference image between the encoding target CTU and the prediction block is Hadamard-transformed and the like.

The encoding cost Cost is represented as follows, assuming that an information amount required for encoding a difference vector MVD=(prediction vector−motion vector) is MVDCost.

Cost=SAD+λ*MVDCost

Where, λ is a scalar to adjust a balance of SAD and MVDCost.

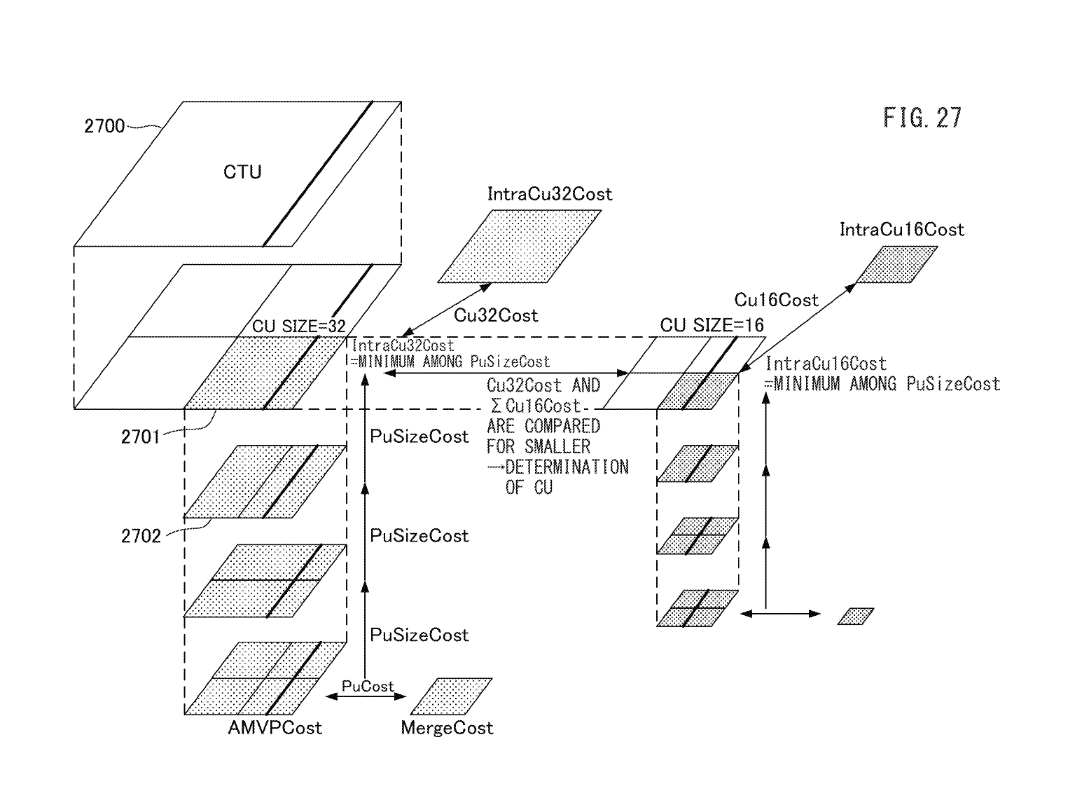

Referring to FIG. 27, a process of the encoding mode determination unit 16 will be explained in more detail. Note that, since a CU being set as invalid will not be selected, the encoding mode determination unit 16 does not calculate encoding costs of combinations including the CU. It will be explained assuming, for simplicity, that CUSIZE=32 and CUSIZE=16 are valid.

First, the encoding mode determination unit 16 sets CUSIZE to 32 in a CTU 2700. The encoding mode determination unit 16 then obtains a cost PuCost of each PU 2702 included in a CU 2701 in order to obtain a cost PuSizeCost for each PU partition mode Part Mode in an encoding target CU. The encoding mode determination unit 16 calculates a PU cost for each of the AMVP mode and the merge mode in determining the inter prediction mode. In this regard, the encoding mode determination unit 16 uses a prediction vector selected by the vector mode determination unit 15 as a prediction vector. As described above, for an inter prediction restriction target PU, a prediction vector is selected from among prediction vector candidates selected in the spatial vector mode. For a PU whose prediction vector is invalid in both AMVP mode and merge mode, i.e., a PU whose prediction vector candidate selected in the spatial vector mode does not exist, the encoding mode determination unit 16 sets the inter prediction mode to be invalid and also sets the PU cost PuCost to an invalid value, i.e., a very large value.

When the AMVP mode is invalid and the merge mode is valid, i.e., when a prediction vector is selected in the merge mode from among prediction vector candidates selected in the spatial vector mode, the encoding mode determination unit 16 sets the inter prediction mode to be the merge mode. The encoding mode determination unit 16 then sets the PU cost PuCost to be a merge mode cost MergeCost. Conversely, when the AMVP mode is valid, i.e., a prediction vector is selected in the AMVP mode from among prediction vector candidates selected in the spatial vector mode, and the merge mode is invalid, the encoding mode determination unit 16 sets the inter prediction mode to be the AMVP mode. The encoding mode determination unit 16 then sets the PU cost PuCost to be an AMVP mode cost AMVPCost. Furthermore, when both AMVP mode and merge mode are valid, the encoding mode determination unit 16 sets the inter prediction mode to be a mode corresponding to the minimum value among an AMVP mode cost AMVPCost and a merge mode cost MergeCost. The encoding mode determination unit 16 sets the minimum value to be the PU cost PuCost.

A PU cost PuCost for every PU included in a CU having been calculated, the encoding mode determination unit 16 calculates, as a PU partition mode cost, a sum PuSizeCost=ΣPuCost of PU costs PuCost of all PUs included in the CU for each PU partition mode. The encoding mode determination unit 16 selects a PU partition mode corresponding to the minimum value among PU partition mode costs of all configurable PU partition modes. Furthermore, the encoding mode determination unit 16 sets the minimum value among the PU partition mode costs to be an inter prediction coding mode cost InterCu32Cost for a CU size (in this example, 32) of interest.

In addition, the encoding mode determination unit 16 calculates an intra prediction coding mode cost IntraCu32Cost of intra-prediction-encoding the CU for CUSIZE=32. In this case, the encoding mode determination unit 16 generates respective prediction blocks according to, for example, a generation method of prediction blocks selectable in the intra prediction coding mode defined by the HEVC standard and calculates a cost for each prediction block according to the SAD calculation equation described above. Then, the encoding mode determination unit 16 may set the minimum value among costs for each prediction block to be the cost IntraCu32Cost.

The encoding mode determination unit 16 sets an encoding mode corresponding to the minimum value among the intra prediction coding mode cost IntraCu32Cost and the inter prediction coding mode cost InterCu32Cost to be the encoding mode selected for the CU size. The selected encoding mode is represented by a flag predModeFlag (=the intra prediction coding mode or the inter prediction coding mode). Furthermore, the encoding mode determination unit 16 sets the minimum value to be the cost Cu32Cost of CUSIZE=32. Note that InterCu32Cost is set to an invalid value when there is at least one invalid PU among PUs included in the CU. In this case, the encoding mode determination unit 16 selects the intra prediction coding mode for CUs of CUSIZE=32.

Secondly, the encoding mode determination unit 16 sets CUSIZE to 16 and performs a similar process. Lastly, the encoding mode determination unit 16 obtains the minimum value among the cost Cu32Cost for CUSIZE=32 and the cost Cu16Cost being a total of four PU costs for CUSIZE=16. The encoding mode determination unit 16 then determines the CU size, the PU partition mode and the encoding mode (in addition, the inter prediction mode when it is the inter prediction coding mode) corresponding to the minimum value.

Thus, when there are no prediction vector candidates selected in the spatial vector mode for any one of PUs included in a CU, the encoding mode determination unit 16 determines the encoding mode for the CU including the PU to be the intra prediction coding mode.

Note that, according to a modified embodiment, for a CU whose CU restriction index is other than ‘0’, the encoding mode determination unit 16 may forcibly set the encoding mode of the CU to be the intra prediction coding mode. In this case, a calculation amount required for selecting the encoding mode is reduced.

The prediction encoding unit 17 generates a prediction block for each PU according to the encoding mode determined by the encoding mode determination unit 16 and generates encoded data for each CU by quantizing a prediction error between the prediction block and the PU.

In particular, the prediction encoding unit 17 executes a difference calculation between the coding target PU and the prediction block. The prediction encoding unit 17 then sets an error value corresponding to each pixel in the PU obtained by the difference calculation to be a prediction error signal.

The prediction encoding unit 17 obtains a frequency signal representing a frequency component of the horizontal direction and a frequency component of the vertical direction of the prediction error signal by performing an orthogonal transformation on a prediction error signal of an encoding target TU. For example, the prediction encoding unit 17 obtains a set of Discrete Cosine Transform (DCT) coefficients for each TU as a frequency signal by executing the DCT on the prediction error signal as an orthogonal transform process.

Then, the prediction encoding unit 17 calculates quantization coefficients of the frequency signal by quantizing the frequency signal. The quantization process is a process in which signal values included in a predetermined range is represented by one signal value. The predetermined range is referred to as a quantization width. For example, the prediction encoding unit 17 quantizes a frequency signal by truncating a predetermined number of lower bits corresponding to the quantization width from the frequency signal. The quantization width is determined by a quantization parameter. For example, the prediction encoding unit 17 determines the quantization width to be used according to a function representing a value of the quantization width corresponding to a value of the quantization parameter. The function is set in advance and may be set to be a monotonically increasing function to the quantization parameter.

Alternatively, a plurality of quantization matrices defining quantization widths corresponding to each of frequency components of the horizontal direction and the vertical direction are provided in advance and are stored in a memory included in the prediction encoding unit 17. The prediction encoding unit 17 then selects a certain quantization matrix among the quantization matrices according to the quantization parameter. Then, the prediction encoding unit 17 may determine the quantization width corresponding to each frequency component of the frequency signal by referring to the selected quantization matrix.

The prediction encoding unit 17 may determine a quantization parameter according to any one of a variety of methods for determining the quantization parameter compliant with video encoding standards such as HEVC. The prediction encoding unit 17 may use, for example, a method of calculating quantization parameters relevant to the standard test model 5 of MPEG-2. With regard to a method of calculating quantization parameters relevant to the standard test model 5 of MPEG-2, the URL specified by, for example, http://www.mpeg.org/MPEG/MSSG/tm5/Ch10/Ch10.html may be referred to.

Since a number of bits used for representing each frequency component of the frequency signal can be decreased by executing the quantization process, the prediction encoding unit 17 may decrease an information amount included in an encoding target TU. The prediction encoding unit 17 outputs the quantization coefficients as encoded data to the entropy encoding unit 18.

Furthermore, the prediction encoding unit 17 generates a reference picture for encoding blocks subsequent to the block from the quantization coefficients of the encoding target TU. For this reason, the prediction encoding unit 17 performs inverse quantization on the quantization coefficients by multiplying the quantization coefficients by a predetermined number corresponding to the quantization width determined by the quantization parameter. By means of this inverse quantization, the frequency signal of the coding target TU, for example, a set of DCT coefficients is reconstructed. Subsequently, the prediction encoding unit 17 performs inverse orthogonal transform process on the frequency signal. For example, when the prediction encoding unit 17 calculates the frequency signal by using DCT, the prediction encoding unit 17 performs inverse DCT process on the reconstructed frequency signal. By performing the inverse quantization process and the inverse orthogonal transform process on the quantized signal, a prediction error signal including information at the same level as the prediction error signal before encoding is reproduced.

The prediction encoding unit 17 adds, to each pixel value of the prediction block, the reproduced prediction error signal corresponding to the pixel. By performing these processes for each block, the prediction encoding unit 17 generates a reference block being used for generating a prediction block for a PU to be encoded subsequently.

The prediction encoding unit 17 stores reference blocks in the memory included in the prediction encoding unit 17 every time a reference block is generated.

The memory included in the prediction encoding unit 17 temporarily stores the reference blocks generated sequentially. By combining the reference blocks constituting one picture according to an encoding sequence of each block, a reference picture to be referred to at a time of encoding subsequent pictures is obtained. The memory included in the prediction encoding unit 17 stores a predetermined number of reference pictures to which an encoding target picture may refer and sequentially discards a reference picture in a chronological sequence of encoding when the number of the reference pictures exceeds the predetermined number.

Furthermore, the memory included in the prediction encoding unit 17 stores a motion vector for each of inter-encoded reference blocks.

The prediction encoding unit 17 performs block matching between an encoding target PU and a reference picture in order to generate a prediction block for inter-encoding and obtains a motion vector by determining a reference picture which most closely matches the encoding target PU and a position of a region on the reference picture.

The prediction encoding unit 17 generates a prediction block according to the encoding mode selected by the encoding mode determination unit 16. When an encoding target PU is inter-prediction-encoded, the prediction encoding unit 17 generates a prediction block by motion-compensating the reference picture based on the motion vector.

Furthermore, when an encoding target PU is intra-prediction-encoded, the prediction encoding unit 17 generates a prediction block from blocks adjacent to the encoding target PU. In this regard, the prediction encoding unit 17 generates the prediction block according to an intra mode defined by the encoding mode determination unit 16 among a variety of intra modes defined in HEVC.

The entropy encoding unit 18 outputs a bitstream obtained by entropy-encoding a quantized signal, a prediction error signal of a motion vector and the like outputted from the prediction encoding unit 17. The control unit (not depicted) obtains encoded video data by combining the outputted bitstream in a predetermined sequence and adding header information and the like defined by an encoding standard such as HEVC.

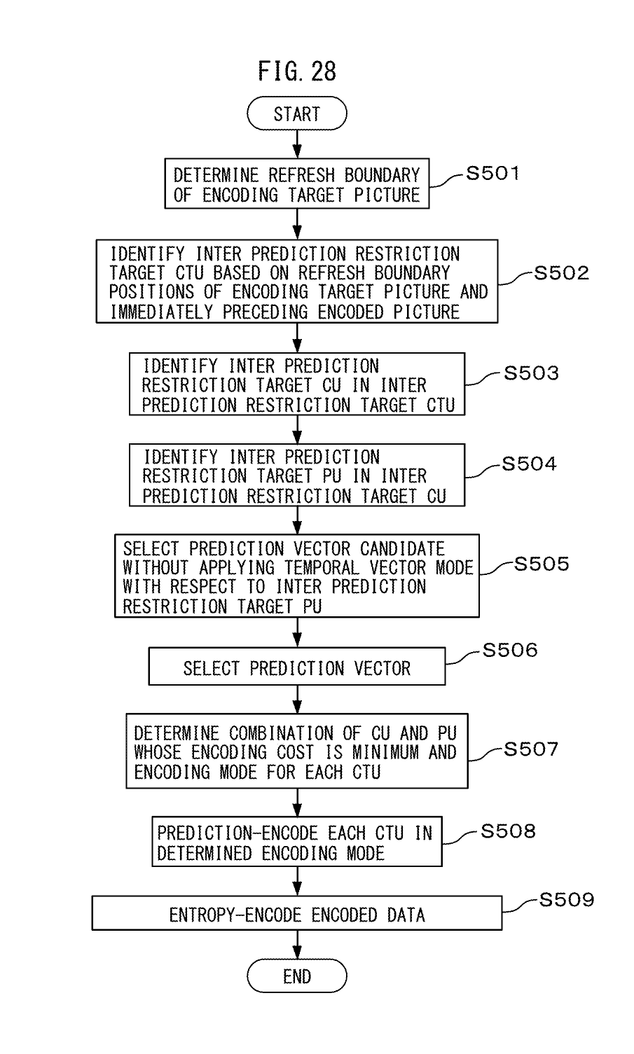

FIG. 28 is an operational flowchart of a video encoding process by the video encoder 1. The video encoder 1 encodes each picture according to the operational flowchart described below. A refresh cycle is set at the start of operation of the video encoder 1. The control unit (not depicted) determines a refresh update size between two consecutive pictures based on the refresh cycle and the picture size.

The refresh boundary determination unit 10 determines a position of a refresh boundary of an encoding target picture from a refresh update size and a refresh boundary position of an immediately preceding encoded picture (step S501). The inter prediction restriction target CTU determination unit 12 identifies a CTU to which application of the inter prediction coding mode is restricted, based on the refresh boundary positions of the encoding target picture and the immediately preceding encoded picture (step S502).

The inter prediction restriction target CU determination unit 13 identifies a CU, to which application of the inter prediction coding mode is restricted, in the CTU to which application of the inter prediction coding mode is restricted (step S503). Note that, for a sub-block (CU, PU) in a CTU to which application of the inter prediction coding mode is not restricted, the inter prediction coding mode can be applied.

The inter prediction restriction target PU determination unit 14 identifies a PU, to which application of the inter prediction coding mode is restricted, in the CU to which application of the inter prediction coding mode is restricted (step S504). Note that, for a PU in a CU to which application of the inter prediction coding mode is not restricted, the inter prediction coding mode can be applied.

The vector mode determination unit 15 selects a prediction vector candidate for a PU, to which application of the temporal vector mode is prohibited, without applying the temporal vector mode. Whereas, the vector mode determination unit 15 selects a prediction vector candidate for a PU, to which application of the inter prediction coding mode is not prohibited, by applying the temporal vector mode (step S505). Then, the vector mode determination unit 15 selects a prediction vector among prediction vector candidates for each PU (step S506).

The encoding mode determination unit 16 determines, for each CTU, a combination of a CU and a PU whose encoding cost becomes minimum and an encoding mode to be applied (step S507). In this regard, for a CU including a PU to which application of the inter prediction coding mode is restricted, the encoding mode determination unit 16 calculates an encoding cost without using the prediction vector candidate selected in the temporal vector mode according to the restriction. Furthermore, the encoding mode determination unit 16 determines a combination of a CU and a PU so as not to select a CU being set to be invalid.

The prediction encoding unit 17 prediction-encodes each CTU according to the determined encoding mode (step S508). The entropy encoding unit 18 entropy-encodes encoded data obtained by prediction-encoding (step S509). Following step S509, the video encoder 1 terminated the video encoding process.

As having been described above, the intra-refresh scheme is applied in the video encoder. The video encoder identifies a PU, among PUs in a refreshed region of an encoding target picture, which is possible to select a motion vector of a block in an unrefreshed region of an encoded picture preceding to the encoding target picture as a prediction vector candidate. The video encoder may prevent that an error in the unrefreshed region is propagated into the refreshed region by restricting application of the temporal vector mode to the identified PU.

According to a modified embodiment, the video encoder may set a refresh boundary horizontally for a picture as illustrated in FIG. 1A and shift the refresh boundary in the vertical direction. In this case, the inter prediction restriction target CTU determination unit 12 determines a CTU to which application of the inter prediction coding mode is restricted as will be explained in the following. Note that, in a modified embodiment, a shift direction of the refresh boundary and a process of the inter prediction restriction target CTU determination unit 12 are different compared to the embodiment described above. Thus, in the following, the inter prediction restriction target CTU determination unit 12 will be explained. However, since the refresh boundary is horizontal, an index of each CTU, CU and PU explained above becomes an index in the vertical direction. In addition, since a PU is not square, the video encoder derives a PU restriction map according a vertical size PUVSIZE.

The inter prediction restriction target CTU determination unit 12 identifies a CTU, to which application of the inter prediction coding mode is restricted, based on refresh boundary positions of an encoding target picture and an immediately preceding encoded picture. Firstly, an index of the vertical direction CTUVIDX for a CTU will be explained.

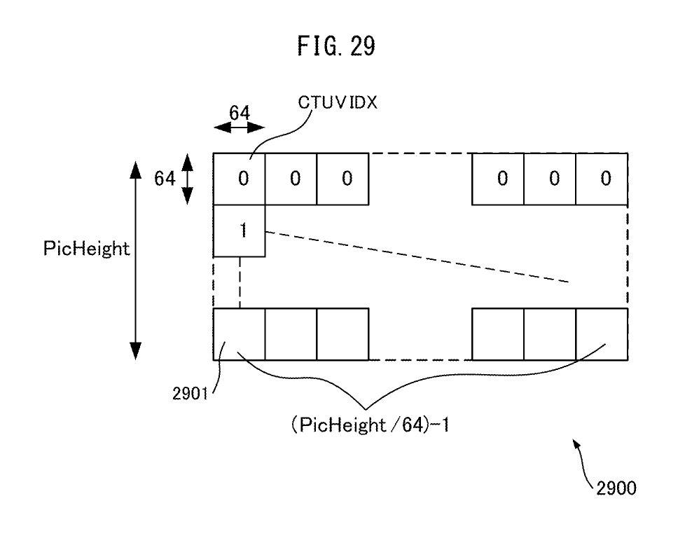

A picture 2900 is divided into a plurality of CTUs 2901 as illustrated in FIG. 29. The index of the vertical direction CTUVIDX for each CTU is sequentially assigned from CTUs at the upper end since the refresh boundary is assumed to move from the upper end to the lower end. In other words, CTUVIDXs for the CTUs at the upper end are zero and CTUVIDXs for CTUs at the (N+1)th from the upper end are N. CTUVIDXs for CTUs at the lower end are (PicHeight/CTUSIZE)−1. Note that PicHeight is the size of the picture of the vertical direction.

A case is considered in which an error has occurred which makes it impossible for a picture to be correctly decoded due to a transmission error or the like in the intra-refresh scheme in which a refresh boundary moves in the vertical direction as illustrated in FIG. 1A. As described above, the error which makes it impossible for a picture to be correctly decoded occurs in units of a CTU.

It is assumed that an error has occurred in a CTU including an unrefreshed region of an encoded picture preceding to an encoding target picture. When the refresh boundary is in the CTU and the error has occurred in the unrefreshed region side of the CTU, the error is propagated into the refreshed region since the entire CTU including the refreshed region becomes erroneous.

Furthermore, the error is propagated into CTUs including the refresh boundary subsequent to the CTU. Therefore, in this case, the video decoder is unable to correctly decode the picture unless the refresh boundary is shifted another cycle. Accordingly, it is sufficient when only those cases are considered that an error has occurred in CTU lines immediately subsequent to the CTU including the refresh boundary.

In order to prevent an error propagation among pictures, the video encoder prevents that a CU or a PU included in a refreshed region of an encoding target picture refers to information of CTU lines subsequent to a CTU line including a refresh boundary of an encoded picture immediately preceding to an encoding target picture.

Accordingly, from the influence range of the temporal vector mode, the inter prediction restriction target CTU determination unit 12 determines, as inter prediction restriction target blocks, CTUs included in each CTU line from a CTU line in the encoding target picture located at the same position as a CTU line including the refresh boundary of the immediately preceding encoded picture or a CTU line whose end portion (in this case, the upper portion) of the source side of the refresh boundary of the immediately preceding encoded picture is adjacent to the position of the refresh boundary of the immediately preceding encoded picture to a CTU line including the refresh boundary of the encoding target picture or a CTU line whose end portion (in this case, the lower end) of the move destination side of the refresh boundary is adjacent to the refresh boundary. In other words, the inter prediction restriction target CTU determination unit 12 determines CTUs having CTUIDXs between r(t−1)/CTUSIZE and r(t)/CTUSIZE as inter prediction restriction target blocks.

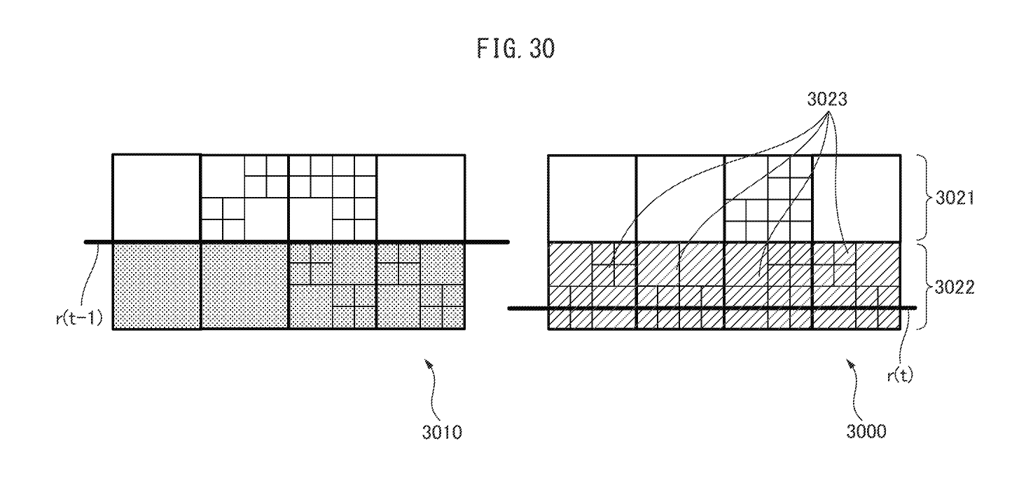

FIG. 30 is a diagram illustrating an example of inter prediction restriction target blocks according to a modified embodiment. In an encoded picture 3010 immediately preceding to an encoding target picture 3000, it is assumed that a refresh boundary r(t−1) is located between a CTU line 3021 and a CTU line 3022. It is also assumed that a refresh boundary r(t) is located in the CTU line 3022 in the encoding target picture 3000. In this case, each CTU 3023 included in the CTU line 3022 becomes the inter prediction restriction target block.

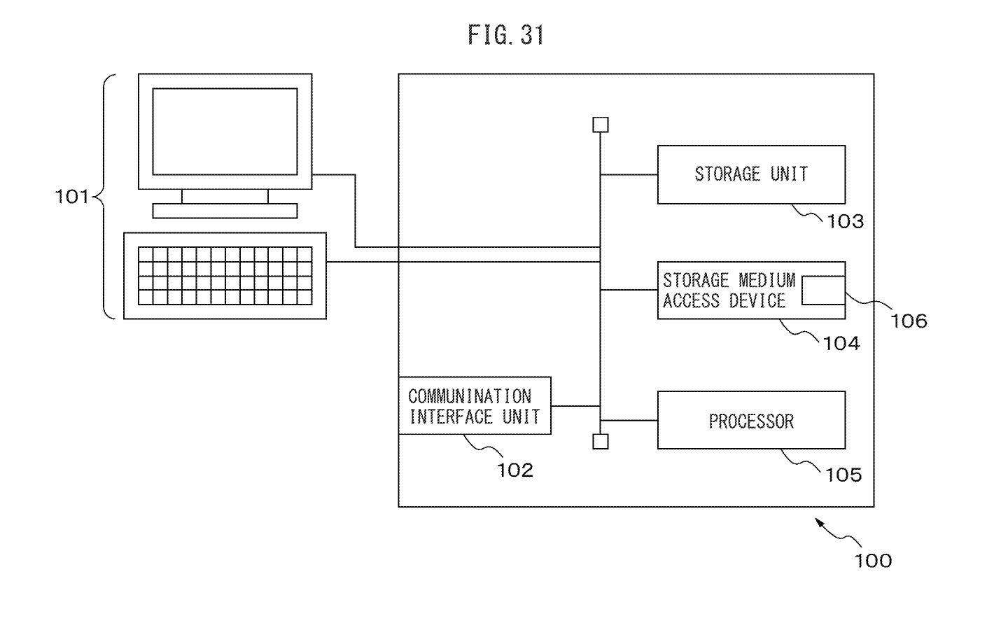

FIG. 31 is a configuration diagram of a computer which operates as a video encoder by executing a computer program implementing a function of each unit of the video encoder according to the embodiment described above or modifications thereof.

A computer 100 includes a user interface unit 101, a communication interface unit 102, a storage unit 103, a storage medium access device 104 and a processor 105. The processor 105 is connected to the user interface unit 101, the communication interface unit 102, the storage unit 103 and the storage medium access device 104 via, for example, a bus.

The user interface unit 101 includes, for example, an input device such as a keyboard and a mouse and a display device such as a liquid crystal display. Alternatively, the user interface unit 101 may include a device into which an input device and a display device are integrated such as a touch panel display. The user interface unit 101 outputs, for example, to the processor 105 an operation signal for selecting video data to be encoded or encoded video data to be decoded in response to a user operation. Furthermore, the user interface unit 101 may display decoded video data received from the processor 105.

The communication interface unit 102 may include a communication interface and a control circuit thereof for connecting the computer to a device for generating video data, for example, a video camera. Such a communication interface may be, for example, a Universal Serial Bus (USB).

Furthermore, the communication interface unit 102 may include a communication interface and a control circuit thereof for connecting a communication network compliant with a communication standard such as Ethernet (registered trade mark).

In this case, the communication interface unit 102 obtains video data to be encoded from other devices connected to the communication network to pass the data to the processor 105. In addition, the communication interface unit 102 may output encoded video data received from the processor 105 to other devices via the communication network.

The storage device 103 includes, for example, a readable and writable semiconductor memory and a read-only semiconductor memory. The storage device 103 stores a computer program to be executed on the processor 105 for performing a video encoding process and data to be generated during or as a result of the process.

The storage medium access device 104 is a device for accessing a storage medium 106 such as, for example, a magnetic disk, a semiconductor memory card and an optical storage medium. The storage medium access device 104 reads a computer program for a video encoding process, which is stored in the storage medium 106 and being executed on the processor 105, to pass to the processor 105.

The processor 105 generates encoded video data by executing the computer program for the video encoding process according to the embodiment described above or modifications thereof. The processor 105 then stores the generated encoded video data in the storage unit 103 or outputs it to other devices via the communication interface unit 102.

Note that a computer program which can execute a function of each unit of the video encoder 1 on a processor may be provided in a form recorded on a medium readable by a computer. However, a carrier is not included in such a medium.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A video encoder which encodes a plurality of pictures included in a video in an intra-refresh scheme comprising:
a refresh boundary determination unit which determines, according to a position of a boundary between a refreshed region through which a slice to which an intra-refresh is applied has traversed and an unrefreshed region through which the slice to which the intra-refresh is applied has not traversed, in a first picture, which has been encoded, among the plurality of pictures, and a refresh update size being a ratio of a size of the pictures in a moving direction of the boundary to a refresh cycle, a position of the boundary in a second picture, which is an encoding target, subsequent to the first picture;
a restriction block identification unit which identifies, based on the position of the boundary of the first picture and the position of the boundary of the second picture, among a plurality of first sub-blocks being units of motion compensation included in the second picture, as a first restriction target sub-block, a first sub-block which is included in the refreshed region in the second picture and is possible to select a motion vector of a sub-block included in the unrefreshed region of the first picture as a prediction vector of the motion vector of the first sub-block when the first sub-block is encoded in an inter prediction coding mode referring to another encoded picture;
a prediction encoding unit which generates encoded data by encoding, among a plurality of second sub-blocks which are obtained by dividing the second picture and are units to be applied in the inter prediction coding mode or in an intra prediction coding mode in which only a coding target picture is referred to, a second restriction target sub-block, which is a second sub-block including the first restriction target sub-block, in the inter prediction coding mode without using the prediction vector with respect to the first restriction target sub-block, or by encoding the second restriction target sub-block in the intra prediction coding mode; and
an entropy encoding unit which entropy-encodes the encoded data.

2. The video encoder according to claim 1, wherein the restriction block identification unit comprises:
an inter prediction restriction target block determination unit which determines, as an inter prediction restriction target block, among a plurality of blocks which are obtained by dividing the second picture, are units of an encoding process to be applied and include at least one of the second sub-blocks, a block which prevents an error from propagating into a refreshed region of the second picture by restricting application of the inter prediction coding mode even when the error occurs in an unrefreshed region of the first picture, the error preventing the first picture from being decoded correctly; and
an inter prediction restriction target sub-block determination unit which determines, as the second restriction target sub-block, a second sub-block including the first restriction target sub-block among the second sub-blocks included in the inter prediction restriction target block.

3. The video encoder according to claim 2, wherein the moving direction of the boundary is a horizontal direction, and
the inter prediction restriction target block determination unit identifies, as the inter prediction restriction target block, a block which is included in columns of blocks from a column of a vertical direction of the block which includes the position of the boundary in the first picture or whose end portion of a move destination side of the boundary is adjacent to the position of the boundary in the first picture to a column of a vertical direction of the block which includes the boundary in the second picture or whose end portion of a move destination side of the boundary is adjacent to the boundary, and is located at a lower end of the second picture.

4. The video encoder according to claim 2, wherein the moving direction of the boundary is a vertical direction, and
the inter prediction restriction target block determination unit identifies, as the inter prediction restriction target block, a block which is included in rows of blocks from a row of a horizontal direction of the block which includes the position of the boundary in the first picture or whose end portion of a move destination side of the boundary is adjacent to the position of the boundary in the first picture to a row of a horizontal direction of the block which includes the boundary in the second picture or whose end portion of a move destination side of the boundary is adjacent to the boundary.

5. The video encoder according to claim 2, further comprising an encoding mode determination unit which calculates an estimation value of an amount of code of the second restriction target sub-block when the intra prediction coding mode is applied and an estimation value of an amount of code of the second restriction target sub-block when the inter prediction coding mode is applied and a temporal prediction vector is not used for the first restriction target sub-block in the second restriction target sub-block, and sets an encoding mode being applied to the second restriction target sub-block to be an encoding mode in which the estimation value is minimum among the intra prediction coding mode and the inter prediction coding mode.

6. The video encoder according to claim 5, wherein the encoding mode determination unit sets an encoding mode being applied to the second restriction target sub-block including the first restriction target sub-block to be the intra prediction coding mode when a motion vector does not exist which can be used as a prediction vector of a motion vector of the first restriction target sub-block in sub-blocks neighboring the first restriction target sub-block.

7. The video encoder according to claim 5, wherein
a size of the second sub-block is selectable among a plurality of sizes,
the inter prediction restriction target sub-block determination unit identifies the second restriction target sub-block for each of the plurality of sizes with respect to the inter prediction restriction target block, and
the encoding mode determination unit determines a size of the second sub-block and the encoding mode to be applied such that the amount of code of the inter prediction restriction target block is minimum among combinations of the plurality of sizes and the intra prediction coding mode and the inter prediction coding mode, with respect to the inter prediction restriction target block.

8. The video encoder according to claim 7, wherein the encoding mode determination unit sets a size of the second restriction target sub-block to be a minimum size among a plurality of sizes selectable with respect to the second sub-block.

9. The video encoder according to claim 2, wherein the restriction block identification unit sets a first sub-block whose right end or lower end is adjacent to a boundary between the plurality of blocks among the first sub-blocks included in the inter prediction restriction target block to be the first restriction target sub-block.

10. The video encoder according to claim 2, wherein
the inter prediction coding mode comprises a plurality of inter prediction modes whose selection methods of prediction vectors are different from each other, and
the video encoder further comprises a vector mode determination unit which applies, with respect to a first prediction mode among the plurality of inter prediction modes, the first prediction mode as the inter prediction coding mode being applied to the first restriction target sub-block when a motion vector neighboring the first restriction target sub-block is available as a prediction vector of a motion vector of the first restriction target sub-block.

11. A video encoding method for encoding a plurality of pictures included in a video in an intra-refresh scheme comprising:
determining, by a processor, according to a position of a boundary between a refreshed region through which a slice to which an intra-refresh is applied has traversed and an unrefreshed region through which the slice to which the intra-refresh is applied has not traversed, in a first picture, which has been encoded, among the plurality of pictures, and a refresh update size being a ratio of a size of the pictures in a moving direction of the boundary to a refresh cycle, a position of the boundary in a second picture, which is an encoding target, subsequent to the first picture;
identifying, by the processor, based on the position of the boundary of the first picture and the position of the boundary of the second picture, among a plurality of first sub-blocks being units of motion compensation included in the second picture, as a first restriction target sub-block, a first sub-block which is included in the refreshed region in the second picture and is possible to select a motion vector of a sub-block included in the unrefreshed region of the first picture as a prediction vector of the motion vector of the first sub-block when the first sub-block is encoded in an inter prediction coding mode referring to another encoded picture;
generating, by the processor, encoded data by encoding, among a plurality of second sub-blocks which are obtained by dividing the second picture and are units to be applied in the inter prediction coding mode or in an intra prediction coding mode in which only a coding target picture is referred to, a second restriction target sub-block, which is a second sub-block including the first restriction target sub-block, in the inter prediction coding mode without using the prediction vector with respect to the first restriction target sub-block, or by encoding the second restriction target sub-block in the intra prediction coding mode; and
entropy-encoding the encoded data by the processor.

12. The video encoding method according to claim 11, further comprises:
determining, by the processor, as an inter prediction restriction target block, among a plurality of blocks which are obtained by dividing the second picture, are units of an encoding process to be applied and include at least one of the second sub-blocks, a block which prevents an error from propagating into a refreshed region of the second picture by restricting application of the inter prediction coding mode even when the error occurs in an unrefreshed region of the first picture, the error preventing the first picture from being decoded correctly; and
determining, by the processor, as the second restriction target sub-block, a second sub-block including the first restriction target sub-block among the second sub-blocks included in the inter prediction restriction target block.

13. The video encoding method according to claim 12, wherein the moving direction of the boundary is a horizontal direction, and
the determining the inter prediction restriction target block identifies, as the inter prediction restriction target block, a block which is included in columns of blocks from a column of a vertical direction of the block which includes the position of the boundary in the first picture or whose end portion of a move destination side of the boundary is adjacent to the position of the boundary in the first picture to a column of a vertical direction of the block which includes the boundary in the second picture or whose end portion of a move destination side of the boundary is adjacent to the boundary, and is located at a lower end of the second picture.

14. The video encoding method according to claim 12, wherein the moving direction of the boundary is a vertical direction, and
the determining the inter prediction restriction target block identifies, as the inter prediction restriction target block, a block which is included in rows of blocks from a row of a horizontal direction of the block which includes the position of the boundary in the first picture or whose end portion of a move destination side of the boundary is adjacent to the position of the boundary in the first picture to a row of a horizontal direction of the block which includes the boundary in the second picture or whose end portion of a move destination side of the boundary is adjacent to the boundary.

15. The video encoding method according to claim 12, further comprising:
calculating, by the processor, an estimation value of an amount of code of the second restriction target sub-block when the intra prediction coding mode is applied and an estimation value of an amount of code of the second restriction target sub-block when the inter prediction coding mode is applied and a temporal prediction vector is not used for the first restriction target sub-block in the second restriction target sub-block; and
setting, by the processor, an encoding mode being applied to the second restriction target sub-block to be an encoding mode in which the estimation value is minimum among the intra prediction coding mode and the inter prediction coding mode.

16. The video encoding method according to claim 15, wherein the setting the encoding mode being applied to the second restriction target sub-block sets an encoding mode being applied to the second restriction target sub-block including the first restriction target sub-block to be the intra prediction coding mode when a motion vector does not exist which can be used as a prediction vector of a motion vector of the first restriction target sub-block in sub-blocks neighboring the first restriction target sub-block.

17. The video encoding method according to claim 15, wherein
a size of the second sub-block is selectable among a plurality of sizes,
the determining the second restriction target sub-block determines the second restriction target sub-block for each of the plurality of sizes with respect to the inter prediction restriction target block, and
the setting the encoding mode being applied to the second restriction target sub-block determines a size of the second sub-block and the encoding mode to be applied such that the amount of code of the inter prediction restriction target block is minimum among combinations of the plurality of sizes and the intra prediction coding mode and the inter prediction coding mode, with respect to the inter prediction restriction target block.

18. The video encoding method according to claim 17, wherein the setting the encoding mode being applied to the second restriction target sub-block sets a size of the second restriction target sub-block to be a minimum size among a plurality of sizes selectable with respect to the second sub-block.

19. The video encoding method according to claim 12, wherein the identifying the first restriction target sub-block sets a first sub-block whose right end or lower end is adjacent to a boundary between the plurality of blocks among the first sub-blocks included in the inter prediction restriction target block to be the first restriction target sub-block.

20. The video encoding method according to claim 12, wherein
the inter prediction coding mode comprises a plurality of inter prediction modes whose selection methods of prediction vectors are different from each other, and
the video encoding method further comprises:
applying, by the processor, with respect to a first prediction mode among the plurality of inter prediction modes, the first prediction mode as the inter prediction coding mode being applied to the first restriction target sub-block when a motion vector neighboring the first restriction target sub-block is available as a prediction vector of a motion vector of the first restriction target sub-block.

21. A non-transitory computer-readable recording medium having recorded thereon a video encoding computer program that causes a computer to execute encoding of a plurality of pictures included in a video in an intra-refresh scheme, the video encoding computer program that causes the computer to execute a process comprising:
determining, according to a position of a boundary between a refreshed region through which a slice to which an intra-refresh is applied has traversed and an unrefreshed region through which the slice to which the intra-refresh is applied has not traversed, in a first picture, which has been encoded, among the plurality of pictures, and a refresh update size being a ratio of a size of the pictures in a moving direction of the boundary to a refresh cycle, a position of the boundary in a second picture, which is an encoding target, subsequent to the first picture;
identifying, based on the position of the boundary of the first picture and the position of the boundary of the second picture, among a plurality of first sub-blocks being units of motion compensation included in the second picture, as a first restriction target sub-block, a first sub-block which is included in the refreshed region in the second picture and is possible to select a motion vector of a sub-block included in the unrefreshed region of the first picture as a prediction vector of the motion vector of the first sub-block when the first sub-block is encoded in an inter prediction coding mode referring to another encoded picture;
generating encoded data by encoding, among a plurality of second sub-blocks which are obtained by dividing the second picture and are units to be applied in the inter prediction coding mode or in an intra prediction coding mode in which only a coding target picture is referred to, a second restriction target sub-block, which is a second sub-block including the first restriction target sub-block, in the inter prediction coding mode without using the prediction vector with respect to the first restriction target sub-block, or by encoding the second restriction target sub-block in the intra prediction coding mode; and
entropy-encoding the encoded data.
